(19) United States
(12) Patent Application Publication
(10) Pub. No.: US 2023/0366111 A1
(43) Pub. Date: Nov. 16, 2023

(54) SINGLE-ATOM CATALYSTS AND METHOD OF MANUFACTURE THEREOF

(71) Applicant: INSTITUT NATIONAL DE LA RECHERCHE SCIENTIFIQUE, Québec (CA)

(72) Inventors: Zonghua PU, Longueuil (CA); Gaixia ZHANG, Ste-Julie (CA); Shuhui SUN, Ste-Julie (CA)

(21) Appl. No.: 18/312,672

(22) Filed: May 5, 2023

Related U.S. Application Data
(60) Provisional application No. 63/364,662, filed on May 13, 2022.

(51) Int. Cl. C25B 11/081; C25B 11/056; C25B 11/065; C25B 11/054; C25D 9/02; C25D 11/00

(52) U.S. Cl. CPC C25B 11/081; C25B 11/056; C25B 11/065; C25B 11/054; C25D 9/02; C25D 11/00

(57) ABSTRACT

We provide a single-atom catalyst comprising nanostructures of a conductive material and a plurality of single-atom metal sites dispersed on the surface of each of the nanostructures. A method of manufacture of such catalyst is also provided. It relies on the electrodeposition or drop casting of the nanostructures of a conductive material on a substrate, followed by the adsorption and electrochemical reduction of complex ions comprising a single atom of each of one or more metal on the surface of the nanostructures.

### CROSS-REFERENCE TO RELATED APPLICATIONS

This application claims benefit, under 35 U.S.C. § 119(e), of U.S. provisional application Ser. No. 63/364,662, filed on May 13, 2022.

### FIELD OF THE INVENTION

The present invention relates to single-atom catalysts and their manufacture. More specifically, the present invention is concerned with low noble metal loading without compromising their mass activities.

### BACKGROUND OF THE INVENTION

With the depletion of fossil fuels (coal, oil, and natural gas), serious environmental pollution, and global warming, the exploration of safe, clean, efficient, sustainable, and environmental-friendly energy sources has become a major social and technological pursuit in the twenty-first century. Hydrogen is regarded as a real clean energy alternative to fossil fuels owing to its high-energy but carbon-free content. The realization of the hydrogen economy has led to the need for efficient and sustainable methods of generation of hydrogen. One of the most attractive technologies is direct electrocatalysis water splitting. Water splitting is thus the main process in clean energy technologies,^{[A1-5]} such as proton exchange membrane (PEM) water electrolyzers and conventional alkaline water electrolyzers.

The process of water electrolysis is based upon two half-reactions: one reaction is oxygen evolution reaction (OER) to generate oxygen, and the other reaction is hydrogen evolution reaction (HER) to produce hydrogen. In the process of HER, an advanced catalyst is required to decrease the overpotential (q) to obtain high efficiency. Up to now, platinum (Pt) group metal-based (PGM-based) materials are generally considered as state-of-the-art electrocatalysts for the HER. Nevertheless, their high cost and limited reservation seriously limit PGM-based materials' large-scale application. Hydrogen evolution reaction (HER) is thus an essential step in water splitting for sustainable hydrogen generation, but the use of rare and expensive precious metal catalysts seriously limits the widespread commercialization of these clean energy devices.^{[A6-11]} In this regard, extensive efforts have been devoted to developing non-Pt and low-Pt electrocatalysts for HER.

On one hand, the past few years have witnessed a rapid development of earth-abundant non-Pt materials (Fe-, Co-, Ni-, Mo-, Cu-, W-, Al-, Zn-, and Mn-based compounds) for efficient HER catalysis in acidic, neutral and alkaline solutions.^{[A12-20]} Nevertheless, for the non-noble compounds, it remains a big challenge to achieve a Pt-like catalytic activity.

Therefore, the development of low-loading, high-activity, and high stability PGM-based catalysts is essential for the widespread commercialization of electrocatalysis water-splitting technology.

To address this issue, developing low-PGM electrocatalysts for HER are highly desired. Lowering the dosage of Pt, using supported Pt nanoparticles on a substrate is a general way to increase the Pt catalytic activity and improve the utilization efficiency. However, the geometry of nanoparticles limits the majority of the Pt atoms to the particle core, making them ineffective, as only the surface atoms are involved in the chemical reaction.^{[A21]}

So far, there have been mainly two different ways to solve this problem. First, alloying Pt together with other 3d transition metals (M=Pd, Ag, Ru, Rh, Fe, Co, Ni, Cu, Cr, Ti, V, Pb, Mn, etc.). Second, downsizing the Pt nanoparticles to single-atom catalysts (SACs) is one of the most effective strategies for improving the Pt utilization efficiency and, therefore, lowering the cost of catalyst materials.

Theoretically, downsizing the platinum particles to single atoms is one of the most effective strategies for improving the Pt utilization efficiency and, therefore, lowering the cost of catalyst materials. It has been proved that single-atom catalysts (SACs) with only isolated single atoms dispersed on a support surface are more reactive than metal particles or clusters in some cases.^{[A22,23]} Indeed, several groups have successfully prepared Pt-based SACs to minimize the amount of Pt metal required to catalyze the HER and other reactions efficiently.^{[A21,24-27]}

In general, there are five important strategies to prepare SACs, including the wet-chemistry method,^{[A28]} atomic layer deposition (ALD),^{[A29]} metal-organic framework (MOF)-derived method,^{[A30]} high-temperature atom trapping from bulk particles,^{[A31]} and vacancies/defects immobilization.^{[A32′33]} However, these methods suffer from severe drawbacks such as low metal loading, high equipment costs, high pyrolysis temperature, and low yields.^{[A34]}

Overall, SACs with ultralow loading, high activity, good selectivity, and high atom utilization efficiency (up to 100%) have attracted much attention in various catalytic fields. However, developing a simple, facile and practical approach to synthesizing SACs material with well-defined sites is very challenging.

### SUMMARY OF THE INVENTION

EMBODIMENT 1. A single-atom catalyst comprising nanofibers of a conductive material and a plurality of single-atom metal sites uniformly dispersed on the surface of each of the nanofibers, wherein each single-atom metal site comprises (preferably consists of) a single atom of each of one or more metal adsorbed on the surface of one of the nanofibers, and wherein the single-atom metal sites contain the same metal(s) or different metals.

EMBODIMENT 2. The catalyst of embodiment 1, wherein the one or more metal are selected from transition metals (e.g., Co, Mo, W, Ni, Fe, Mn, Cu, Sn, In, etc.), rare earth metals (e.g., La, Y, Sc, Ce, Er, Pr, Nd, Dy, etc.), precious/rare metals (e.g., Pt, Ru, Ir, Rh, Au, Pd, etc.), more preferably Pt, Ru, or Ir, and most preferably Pt.

EMBODIMENT 3. The catalyst of 1 or 2, wherein each single-atom metal site comprises (preferably consists of) a single atom of one metal.

EMBODIMENT 4. The catalyst of embodiment 3, wherein the one metal is a transition metal, a rare earth metal, Ru, Pd, or Pt, more preferably Ru, Pd, or Pt, and most preferably Pt.

EMBODIMENT 5. The catalyst of any one of embodiments 2 to 4, wherein the Pt in the catalyst has an oxidation state (δ⁺) of 4>δ⁺>0, preferably 3>δ⁺>1, and more preferably of about 2.

EMBODIMENT 6. The catalyst of any one of embodiments 1 to 5, having a mass loading of the metal of at least about 1.2, preferably at least about 2, more preferably at least about 2.5, yet more preferably at least about 2.6, even more preferably at least about 2.7, and most preferably at least about 2.8 μg cm-2 (μg of metal per cm² of surface of the nanofibers).

EMBODIMENT 7. The catalyst of any one of embodiments 1 to 6, wherein the nanofibers are between about 50 nm and about 500 nm, preferably about 100 nm and about 300 nm, and most preferably about 200 nm in average diameter.

EMBODIMENT 8. The catalyst of any one of embodiments 1 to 7, wherein the conductive material is a metal, a conductive oxide-based porous material, a conductive carbon material, or a conductive polymer, preferably a conductive polymer.

EMBODIMENT 9. The catalyst of embodiment 8, wherein the oxide-based porous material is TiO₂, Fe₂O₃, Fe₃O₄, ZnO, CeO₂, Al₂O₃, ZrO₂, CuO, WO₃, Co₃O₄, MgO, preferably TiO₂, Fe₂O₃, or ZnO.

EMBODIMENT 10. The catalyst of embodiment 8 or 9, wherein the conductive carbon material is graphene, graphdiyne, carbon nanotubes, or carbon black, preferably graphene.

EMBODIMENT 11. The catalyst of any one of embodiments 8 to 12, wherein the conductive polymer is poly(pyrrole), polycarbazole, polyindole, polyazepines, polyaniline, poly (3,4-ethylenedioxythiophene), poly(p-phenylene sulfide), preferably poly(pyrrole), or polyaniline, and most preferably polyaniline.

EMBODIMENT 12. The catalyst of any one of embodiments 1 to 11, wherein the nanofibers are nanofibers of a conductive polymer.

EMBODIMENT 13. The catalyst of any one of embodiments 1 to 12, wherein the nanofibers are interconnected with each other.

EMBODIMENT 14. The catalyst of any one of embodiments 1 to 13, wherein the nanofibers form a three-dimensional macroporous structure.

EMBODIMENT 15. The catalyst of any one of embodiments 1 to 14, wherein the surface of each of the nanofibers is rough, preferably the surface of each of the nanofibers bears protrusions, more preferably pointed protrusions.

EMBODIMENT 16. The catalyst of any one of embodiments 1 to 5, wherein the surface of each of the nanofibers is free or substantially free from all materials except the plurality of single-atom metal sites.

EMBODIMENT 17. The catalyst of any one of embodiments 1 to 16, wherein the nanofibers are supported onto a conductive substrate, more preferably a current collector.

EMBODIMENT 18. The catalyst of embodiment 17, wherein the conductive substrate is Ni, Co, Fe, Cu, Ti, Mo, a metal-based foam, plate, or mesh, carbon cloth, carbon paper, or graphite foam, preferably a Ti mesh, Cu foam, Ni foam, or carbon cloth, and most preferably carbon cloth.

EMBODIMENT 19. The catalyst of embodiment 17 or 18, wherein a surface of the conductive substrate is uniformly covered by the nanofibers.

EMBODIMENT 20. The catalyst of any one of embodiments 1 to 19, exhibiting an X-ray diffraction (XRD) pattern that is free of diffraction peaks related to clusters or nanoparticles of the metal(s); preferably when the metal is Pt, the XRD pattern of the catalyst is free of diffraction peaks related to clusters or nanoparticles of Pt at 39.6, 47.4, and 67.1°; more preferably the XRD pattern of the catalyst is as shown in FIG. 5.

EMBODIMENT 21. The catalyst of any one of embodiments 1 to 20, wherein when observed by high-resolution transmission electron microscopy (HRTEM), the catalyst appears free of clusters or nanoparticles of the metal(s).

EMBODIMENT 22. The catalyst of any one of embodiments 1 to 21, exhibiting a Fourier Transform Extended X-ray Absorption Fine Structure (FT-EXAFS) spectrum free of a peak related to a metal-metal bond and/or free of a peak related to a metal-chlorine bond; preferably when the metal is Pt, the FT-EXAFS spectrum is free of a peak related to the metal-metal (Pt—Pt) bond at ˜2.7 Å.

EMBODIMENT 23. The catalyst of any one of embodiments 1 to 22, wherein the metal(s) are anchored on nitrogen atoms at the surface of the nanofibers.

EMBODIMENT 24. The catalyst of any one of embodiments 1 to 23, wherein the conductive material comprises a lone electron pair on a N atom.

EMBODIMENT 25. The catalyst of embodiment 24, wherein the conductive material is poly(pyrrole), polycarbazole, polyindole, polyazepine, or polyaniline, preferably poly(pyrrole), or polyaniline, and most preferably polyaniline.

EMBODIMENT 26. The catalyst of embodiment 24 or 25, wherein the N atoms and the single-atom metal sites are homogeneously dispersed on the surface of each of the nanofibers.

EMBODIMENT 27. The catalyst of any one of embodiments 1 to 26, exhibiting a FT-EXAFS spectrum comprising a peak related to a metal-N bond; preferably when the metal is Pt, the peak related to the metal-N bond (Pt—N bond) is at about 1.8 Å and more preferably the catalyst exhibits a FT-EXAFS spectrum as shown in FIG. 10d.

EMBODIMENT 28. A method of manufacturing a single-atom catalyst, the method comprising the steps of:
STEP A. providing a conductive substrate,
STEP B. electrodepositing nanostructures of a conductive material on the substrate or drop-casting a suspension of the nanostructures of a conductive material on the substrate, wherein said nanostructures have a negative surface charge,
STEP C. adsorbing one or more complex ions on the surface of the nanostructures, each complex ion comprising a single atom of each of one or more metal and having a total negative charge, and
STEP D. electrochemical reducing the metal(s), thereby producing the catalyst.

EMBODIMENT 29. The method of embodiment 28, wherein the nanostructures are subnano-clusters, nanoparticles, or nanofibers, preferably nanofibers.

EMBODIMENT 30. The method of embodiment 28 or 29, wherein the catalyst is a catalyst as defined in any one of embodiments 1 to 27.

EMBODIMENT 31. The method of any one of embodiments 28 to 30, wherein step B comprises drop-casting a suspension of the nanostructures of a conductive material on the substrate.

EMBODIMENT 32. The method of embodiment 31, wherein step B comprises preparing a suspension of the nanostructure in a volatile solvent, such as ethanol, drop-casting the suspension on the substrate, and allowing the solvent to evaporate.

EMBODIMENT 33. The method of any one of embodiments 28 to 30, wherein step B comprises electrodepositing nanostructures of a conductive material on the substrate.

EMBODIMENT 34. The method of embodiment 33, wherein step B comprises electrodepositing the nanofibers using a three-electrode assembly comprising an electrolyte, the conductive substrate as a working electrode, a graphite electrode as a counter electrode, and an Ag/AgCl electrode as the reference electrode.

EMBODIMENT 35. The method of embodiment 34, wherein a potential of about 0.6 to about 1.2 V vs. Ag/AgCl, preferably about 0.7 to about 0.9 V vs. Ag/AgCl is applied to the working electrode for a period of about 1 min to about 60 min, preferably about for about 5 to about 30 minutes.

EMBODIMENT 36. The method of embodiment 34 or 35, wherein the electrolyte comprises the conductive material or a monomer of the conductive materiel.

EMBODIMENT 37. The method of any one of embodiments 34 to 36, wherein the conductive material is polyaniline, and the electrolyte comprises aniline, preferably about 1 to about 10 v/v % of aniline, and more preferably about 2 to about 5 v/v % of aniline, based on the totally volume of the electrolyte.

EMBODIMENT 38. The method of any one of embodiments 34 to 37, wherein the electrolyte further comprises an acid, preferably HCl, HNO₃, H₂SO₄, HClO₄, or phytic acid, and more preferably HCl; preferably between about 1 to about 20 v/v % of the acid, and more preferably between about 4 to about 10 v/v % of the acid, based on the totally volume of the electrolyte.

EMBODIMENT 39. The method of any one of embodiments 34 to 37, further comprising the step of washing, and then preferably drying, the conductive substrate with the electrodeposited nanofibers, wherein water is preferably used for said washing, and wherein the drying is preferably at a temperature of 60 to about 100° C.

EMBODIMENT 40. The method of any one of embodiments 28 to 40, wherein step C comprises immersing the conductive substrate with the nanostructures in a solution comprising the above-mentioned complex ions, and allowing the complex ions to adsorb on the surface of the nanostructures.

EMBODIMENT 41. The method of embodiment 40, wherein the complex ions are: FeF₆³⁻, Co(SCN)₄²⁻, Cr(CN)₆³⁻, Co(CN)₆³⁻, Fe(CN)₆³⁻, Ni(CN)₄²⁻, [Cu(NH₃)Cl₅]³⁻, [CuCl₃(H₂O)]⁻, RuCl₆²⁻, AuCl₄⁻, IrCl₆²⁻, PtCl₆²⁻, and/or PdCl₄²⁻.

EMBODIMENT 42. The method of embodiment 40 or 41, further comprising the step of preparing the solution comprising the complex ions by adding a compound comprising the complex ion to a solvent.

EMBODIMENT 43. The method of embodiment 42, wherein the solvent is methanol, alcohol and water, preferably water, more preferably deionized water.

EMBODIMENT 44. The method of embodiment 42 or 43, wherein the compound comprising the complex ion is an acid or a salt.

EMBODIMENT 45. The method of any one of embodiments 28 to 44, further comprising between step C and D, the step of washing, and then drying the conductive substrate after the complex ions have adsorbed on the surface of the nanostructures, wherein water is preferably used for said washing.

EMBODIMENT 46. The method of any one of embodiments 28 to 45, wherein step D comprises electrochemically reducing the metal(s) using one linear sweep voltammetry (LSV) scan on the.

EMBODIMENT 47. The method of embodiment 46, wherein a voltage is scanned from about 0.2 to about −1.0 V, preferably from about 0 to about −0.8 V, and more preferably from about 0 to about −0.5 V.

EMBODIMENT 48. The method of embodiment 46 or 47, wherein a scan rate of about 0.1 to about 200 mV s⁻¹, preferably of about 1 to about 5 mV s⁻¹ is used.

EMBODIMENT 49. The method of any one of embodiments 46 to 48, wherein a solution of H₂SO₄, HClO₄, KOH, or NaOH, or a phosphoric acid buffer, and more preferably a solution of H₂SO₄, is used as an electrolyte.

### BRIEF DESCRIPTION OF DRAWINGS

In the appended drawings:

FIG. 1 shows a schematic illustration of the synthesis and structure of the PANI-Pt/CC electrocatalyst.

FIG. 2 Photographs of prepared samples: (a) bare carbon cloth (CC), (b) PANI/CC, (c) PANI-H₂PtCl₆/CC.

FIG. 3 (a-b) SEM images of bare CC at increasing magnification.

FIG. 4 (a-c) SEM images of PANI/CC at increasing magnification.

FIG. 5 XRD patterns of PANI/CC and PANI-Pt-10/CC. The XRD pattern of the PANI-Pt-10/CC showed two peaks at ˜26° and 43°, assigned to the (002) and (001) plane of the graphitic carbon. And the diffraction peaks of Pt are not observed.

FIG. 6 (a-c) SEM images of PANI-Pt-10/CC.

FIG. 7 (a and b) TEM and (c and d) HRTEM images of PANI-Pt-10/CC.

FIG. 8 (a and b) STEM images of PANI-Pt-10 catalyst. (c and d) AC-HAADF-STEM images of PANI-Pt-10 at different magnifications. (e-g) EDX elemental mapping of C, N, and Pt, respectively, for the PANI-Pt-10 nanofiber.

FIG. 9 (a and b) The low magnifications AC-HAADF-STEM images of PANI-Pt-10.

FIG. 10 (a) High-resolution XPS Pt 4f pattern of PANI-Pt-10/CC. (b) The normalized XANES spectra at the Pt L3-edge for the Pt foil, PtO₂, and PANI-Pt-10/CC. (c) The average oxidation state of Pt in PANI-Pt-10/CC. (d) Corresponding Fourier transform (FT) of EXAFS spectra for Pt foil, PtO₂, and PANI-Pt-10/CC.

FIG. 11. High-resolution (a) N 1s and (b) O1s XPS spectrum for PANI-Pt-10/CC

FIG. 12 (a) The normalized XANES spectra at the Pt L3-edge for the H₂PtCl₆. (b) Corresponding Fourier transform (FT) of EXAFS spectra for H₂PtCl₆.

FIG. 13 N K-edge XANES spectra of PANI-Pt-10/CC.

FIG. 14 (a) XRD pattern of PANI-Pt-5/CC. The XRD pattern of the PANI-Pt-5/CC showed two peaks at ˜26° and 43°, assigned to the (002) and (001) plane of the graphitic carbon. And the diffraction peaks of Pt are not observed. (b-d) SEM images of PANI-Pt-5/CC.

FIG. 15 (a) XRD pattern of PANI-Pt-20/CC The XRD pattern of the PANI-Pt-20/CC showed two peaks at ˜26° and 43°, assigned to the (002) and (001) plane of the graphitic carbon. And the diffraction peaks of Pt are not observed. (b-d) SEM images of PANI-Pt-20/CC.

FIG. 16 (a) XRD pattern of PANI-Pt-30/CC. The XRD pattern of the PANI-Pt-30/CC showed two peaks at ˜26° and 43°, assigned to the (002) and (001) plane of the graphitic carbon. And the diffraction peaks of Pt are not observed. (b-d) SEM images of PANI-Pt-30/CC.

FIG. 17 AC-HAADF-STEM images of prepared samples by (a) 5 mg, (b) 20 mg and (c) 30 mg H₂PtCl₆·H₂O, respectively.

FIG. 18 High-resolution XPS Pt 4f pattern of (a) PANI-Pt-5/CC, (b) PANI-Pt-20/CC and (c) PANI-Pt-30/CC.

FIG. 19 (a) XRD pattern of PANI-Pd/CC. The XRD pattern of the PANI-Pd/CC showed two peaks at ˜26° and 43°, assigned to the (002) and (001) plane of the graphitic carbon. And the diffraction peaks of Pd are not observed. (b-d) SEM images of PANI-Pd/CC.

FIG. 20 The high-resolution XPS spectra of (a) Pd 3d and (b) N 1s for PANI-Pd/CC.

FIG. 21 (a) XRD pattern of PANI-Ru/CC. The XRD pattern of the PANI-Ru/CC showed two peaks at ˜26° and 43°, assigned to the (002) and (001) plane of the graphitic carbon. And the diffraction peaks of Ru are not observed. (b-d) SEM images of PANI-Ru/CC.

FIG. 22 The high-resolution XPS spectra of (a) Ru 3d+C 1s and (b) N 1s for PANI-Ru/CC.

FIG. 23 Activation process of PANI-Pt-10/CC in 0.5 M H₂SO₄ solution.

FIG. 24 The RHE voltage calibration under acidic solutions.

FIG. 25 (a) HER polarization curves of atomically dispersed Pt sites anchored on PANI prepared by different mass of H₂PtCl₆·H₂O. (b) Corresponding overpotentials at j=10 mA cm⁻². (c) Corresponding Tafel plots. (d) HER polarization curves of PANI-Pt-10/CC, Pt/C, PANI/CC and blank CC in 0.5 M H₂SO₄ at a scan rate of 2 mV s⁻¹. (e) Overpotentials at j=10, 20 and 50 mA cm-2 of Pt/C and PANI-Pt-10/CC. (f) Tafel plots of PANI-Pt-10/CC and Pt/C. (g) HER polarization curves were recorded before and after 1000 CV cycles for PANI-Pt-10/CC and Pt/C in 0.5 M H₂SO₄ solutions. (h) Chronopotentiometric curves of PANI-Pt-10/CC and Pt/C at 10 mA cm-2 in 0.5 M H₂SO₄ for 20 h. (i) HER polarization curves of PANI-Pd/CC and PANI-Ru/CC in 0.5 M H₂SO₄ solutions.

FIG. 26 The polarization curves of the PANI-Pt-10/CC with/without iR correction.

FIG. 27 LSV curves of PANI-Pt-5/CC, PANI-Pt-10/CC, PANI-Pt-20/CC, PANI-Pt-30/CC with current density normalized to the mass of Pt in 0.5 M H₂SO₄ at 2 mV s⁻¹.

FIG. 28 LSV curves of PANI-Pt-10/CC and Pt/C with current density normalized to the mass of Pt in 0.5 M H₂SO₄ at 2 mV s⁻¹.

FIG. 29 The Nyquist plots of PANI-Pt-10/CC at an overpotential of 0 mV with a 5 mV AC potential from 0.1 Hz to 100 kHz. The inset is the equivalent circuit model, where R_{Ω} is the solution resistance, Ra is charge transfer resistance.

FIG. 30 (a and b) SEM images of PANI/CC. (c) XRD pattern of PANI-Pt NPs/CC. (d) LSV curves of PANI-Pt NPs/CC and Pt/C with current density normalized to the mass of Pt in 0.5 M H₂SO₄ at 2 mV s⁻¹.

FIG. 31 (a) The normalized XANES spectra at the Pt L3-edge for the PANI-Pt-10/CC and post-HER PANI-Pt-10/CC. (b) Corresponding Fourier transform (FT) of EXAFS spectra for PANI-Pt-10/CC and post-HER PANI-Pt-10/CC.

FIG. 32 Polarization curves of PANI-Pt-10/CC in 1.0 M KOH and 0.2 M PBS (pH=7).

### DETAILED DESCRIPTION OF THE INVENTION

Turning now to the invention in more details, there is provided a single-atom catalyst (SAC) comprising nanofibers of a conductive material and a plurality of single-atom metal sites uniformly dispersed on the surface of each of the nanofibers, wherein each single-atom metal site comprises a single atom of each of one or more metal adsorbed on the surface of one of the nanofibers, and wherein the single-atom metal sites contain the same metal(s) or different metals.

It has been unexpectedly found that such catalysts, particularly those according to preferred embodiments of the invention, can have mass activities for HER that are nearly 50 times higher than that of commercial catalysts of the same type (see in the Examples below PANI-Pt-10/CC vs commercial Pt/C). Hence, the catalytic activity for HER is significantly enhanced, while the noble metal usage is drastically reduced.

The PANI-Pt-10/CC material also exhibits good catalytic activity under neutral and basic conditions. That is, this single-atom-based material could find its applications in a wide pH range (pH 0-14), which can be easily adapted to the various water electrolyzers such as proton exchange membrane (PEM) and anion exchange membrane (AEM) water electrolyzers, conventional alkaline water electrolyzers, neutral electrolyzers, even hybrid ones (e.g., acid-base, neutral-base).

By changing the nature of the metal(s), the catalysts of the invention can be used for many applications, such as:
H₂ production,
O₂ reduction,
O₂ evolution,
CO₂ reduction
N₂ reduction
Metal-O₂ batteries, such as Li—O₂ batteries,
Metal air batteries,
Fuel cells, in both anodes and cathodes, and
H₂ oxidation reaction.

### The Catalyst

As noted above, the single-atom catalyst of the invention comprises nanofibers of a conductive material and a plurality of single-atom metal sites uniformly dispersed on the surface of each of the nanofibers, wherein each single-atom metal site comprises (preferably consists of) a single atom of each of one or more metal adsorbed on the surface of one of the nanofibers, and wherein the single-atom metal sites contain the same metal(s) or different metals.

For certainty, “a single atom of each of one or more metal” means that the single-atom metal sites may comprise a single atom of one metal (e.g., one atom of Pt), a single atom of each of two metals (e.g., one atom of Pt+one atom of Au), a single atom of each of three metals (e.g., one atom of Pt+one atom of Au+one atom of Ir), etc.

As noted above, the single-atom metal sites in the catalyst of the invention contain the same metal(s) or different metals. This means that a catalyst can comprise sites with one atom of a metal (e.g., Au), sites with one atom of another metal (e.g., Pt), and even sites with one atom of each of two metals (Au+Ir).

Preferably, the single-atom metal sites contain the same metal(s).

As noted, the single-atom metal sites are uniformly dispersed on the surface of each of the nanofibers. Herein, “uniformly dispersed” means that the distribution the single-atom metal sites is constant throughout the surface.

The one or more metals are selected from all metals that are useful as a catalyst, preferably they are selected from transition metals (e.g., Co, Mo, W, Ni, Fe, Mn, Cu, Sn, In, etc.), rare earth metals (e.g., La, Y, Sc, Ce, Er, Pr, Nd, Dy, etc.), precious/rare metals (e.g., Pt, Ru, Ir, Rh, Au, Pd, etc.), more preferably Pt, Ru, or Ir, and most preferably Pt.

In preferred embodiments, each single-atom metal site comprises (preferably consists of) a single atom of one metal. Preferably, the one metal is a transition metal, a rare earth metal, Ru, Pd, or Pt, more preferably Ru, Pd, or Pt, and most preferably Pt.

In preferred embodiments, the Pt in the catalyst has an oxidation state (5′) of 4>δ⁺>0, preferably 3>δ⁺>1, and more preferably of about 2.

In preferred embodiments, the catalyst has a mass loading of the metal of at least about 1.2, preferably at least about 2, more preferably at least about 2.5, yet more preferably at least about 2.6, even more preferably at least about 2.7, and most preferably at least about 2.8 μg cm⁻² (lig of metal per cm² of surface of the nanofibers).

In embodiments, the conductive material forming the nanofibers is a metal, a conductive oxide-based porous material, a conductive carbon material, or a conductive polymer, preferably a conductive polymer.

In embodiments, the oxide-based porous material is TiO₂, Fe₂O₃, Fe₃O₄, ZnO, CeO₂, Al₂O₃, ZrO₂, CuO, WO₃, Co₃O₄, MgO, preferably TiO₂, Fe₂O₃, or ZnO.

In embodiments, the conductive carbon material is graphene, graphdiyne, carbon nanotubes, or carbon black, preferably graphene.

In embodiments, the conductive polymer is poly(pyrrole), polycarbazole, polyindole, polyazepines, polyaniline, poly (3,4-ethylenedioxythiophene), poly(p-phenylene sulfide), preferably poly(pyrrole), or polyaniline, and most preferably polyaniline.

In preferred embodiments, the nanofibers are nanofibers of a conductive polymer. In preferred embodiments, the nanofibers are between about 50 nm and about 500 nm, preferably about 100 nm and about 300 nm, and most preferably about 200 nm in average diameter.

In preferred embodiments, the nanofibers are interconnected with each other.

In preferred embodiments, the nanofibers form a three-dimensional macroporous structure.

In preferred embodiments, the surface of each of the nanofibers is rough, which is beneficial for the absorption of the metal ions during the manufacture of the catalyst. In more preferred embodiments, the surface of each of the nanofibers bears protrusions, preferably pointed protrusions. In other words, it can be said that the surface of each of the nanofibers is jagged. This phenomenon can increase the active surface area of the catalyst, which is further beneficial for improving the catalytic activity.

In preferred embodiments, only the plurality of single-atom metal sites is present on the surface of each of the nanofibers. In other words, the surface of each of the nanofibers is free or substantially free from all materials except the plurality of single-atom metal sites.

In preferred embodiments, the nanofibers of the conductive material are supported onto a conductive substrate, more preferably a current collector. In embodiments, the conductive substrate is Ni, Co, Fe, Cu, Ti, Mo, etc. metal-based foam/plate/mesh, carbon cloth, carbon paper, or graphite foam, preferably Ti mesh, Cu foam, Ni foam, or carbon cloth, and most preferably carbon cloth.

In preferred embodiments, a surface of the conductive substrate is uniformly covered by the nanofibers.

### No Cluster or Nanoparticles

As noted above, each single-atom metal site comprises (preferably consists of) a single isolated atom of each or one or more metal. For more certainty, the single-atom metal sites do not comprise the metal(s) as part of nanoparticles or clusters of metal atoms. In other words, the metal sites are atomically dispersed on the surface of the nanostructures.

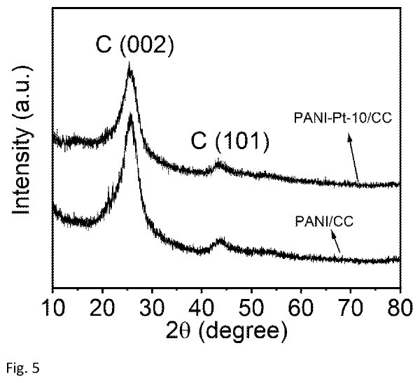

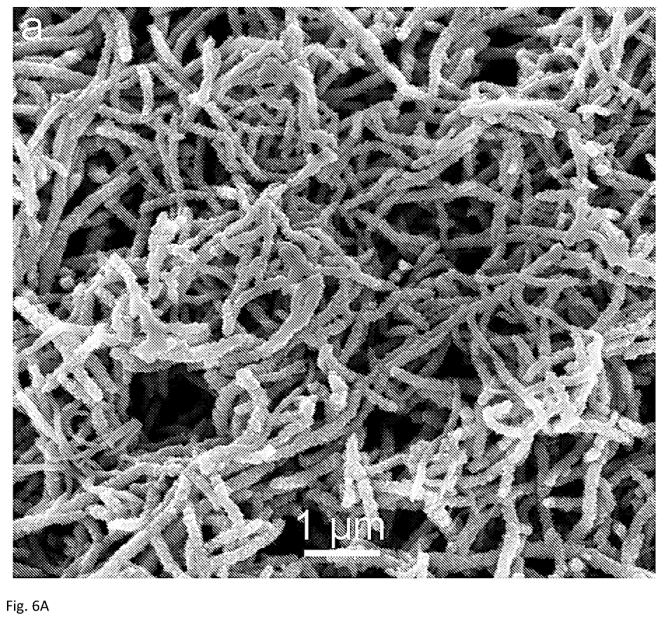

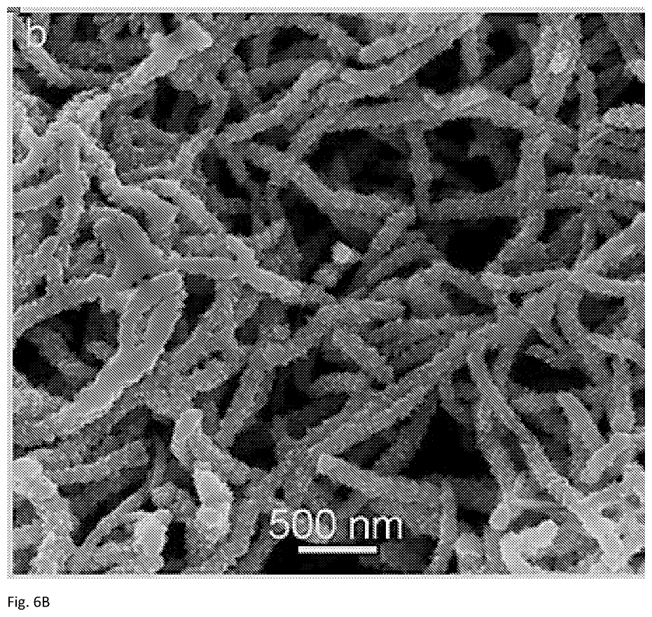

In preferred embodiments, the catalyst exhibits an XRD pattern that is free of diffraction peaks related to clusters or nanoparticles of the metal(s). In such embodiments, when the metal is Pt, the XRD pattern of the catalyst would be free of diffraction peaks related to clusters or nanoparticles of Pt, which would be at 39.6, 47.4, and 67.1°. In preferred such embodiments, the XRD pattern of the catalyst is as shown in FIG. 5.

In preferred embodiments, when observed by high-resolution transmission electron microscopy (HRTEM), the catalyst appears free of clusters or nanoparticles of the metal(s).

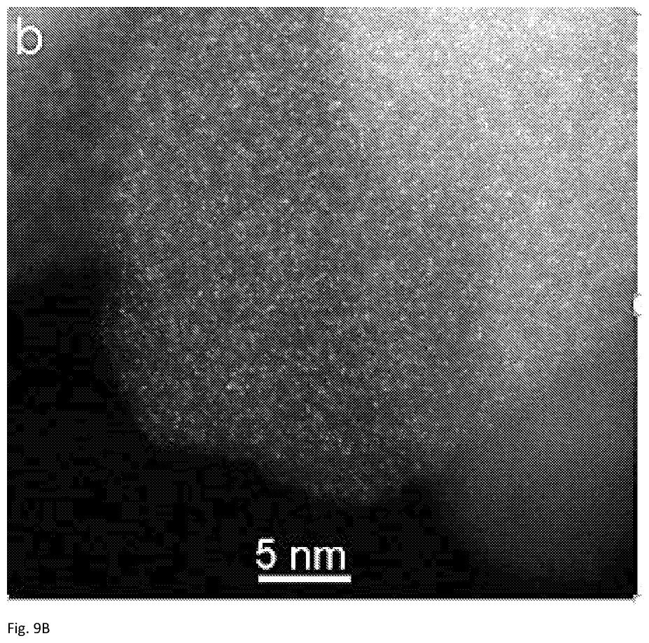

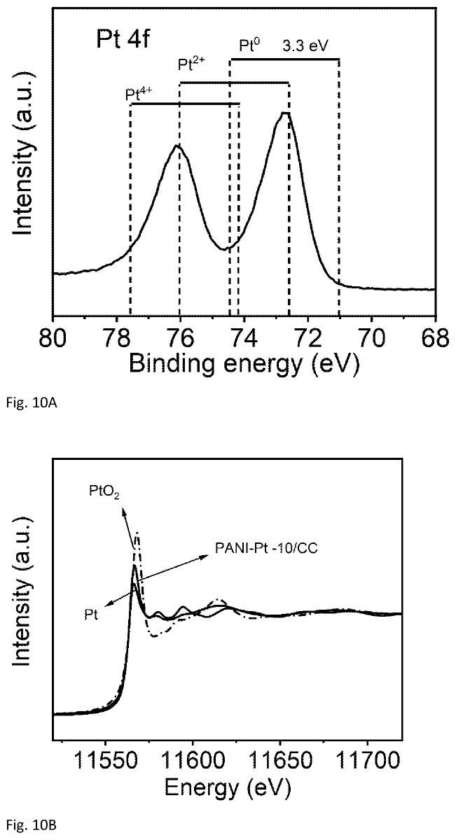

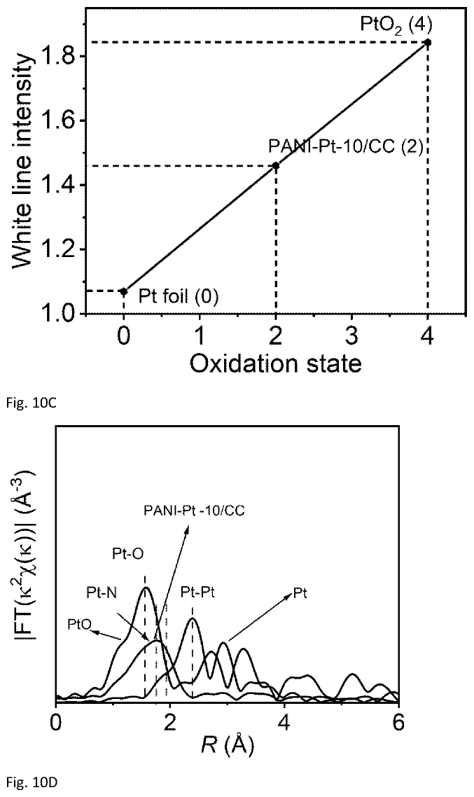

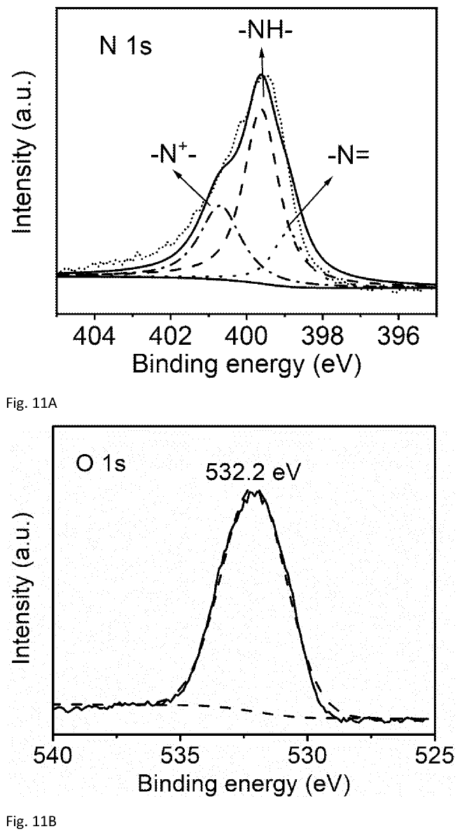

In embodiments, the catalyst exhibits a FT-EXAFS spectrum free of a peak related to a metal-metal bond and/or free of a peak related to a metal-chlorine bond. In embodiments in which the metal is Pt, the peak related to the metal-metal (Pt—Pt) bond would be about at ˜2.7 Å (see FIG. 10d), while the peak related to the Pt—Cl bond would be at about 1.95 Å (see FIG. 12).

### Anchoring on N Atoms

In preferred embodiments, the metal(s) are anchored on nitrogen atoms at the surface of the nanofibers.

In preferred such embodiments, the conductive material (preferably the conductive polymer) comprises a lone electron pair on a N atom. In embodiments, the conductive material comprising a lone electron pair on a N atom is poly(pyrrole), polycarbazole, a polyindole, a polyazepine, or polyaniline, preferably poly(pyrrole), or polyaniline, and most preferably polyaniline.

Such conductive materials with a lone electron pair on a N atom can effectively capture the H⁺ from hydronium ions to form protonated amine groups that can be electro-reduced easily into atomically dispersed metal sites.

In preferred such embodiments, the catalyst exhibits a FT-EXAFS spectrum comprising a peak related to a metal-N bond. In embodiments in which the metal is Pt, the peak related to the metal-N bond (Pt—N bond) is at about 1.8 Å. In more preferred embodiments, the catalyst exhibits a FT-EXAFS spectrum as shown in FIG. 10d.

In preferred such embodiments, the N atoms and the single-atom metal sites are homogeneously dispersed on the surface of each of the nanofibers. Herein, “homogenously dispersed” means that the composition of the surface, when considering the N atoms and the single-atom metal sites, is uniform throughout the surface. In preferred such embodiments, the Other advantages of polyaniline include having a high electrochemical conductivity, being easily prepared in an aqueous medium, being chemically stable, and being highly conductive in acidic media.

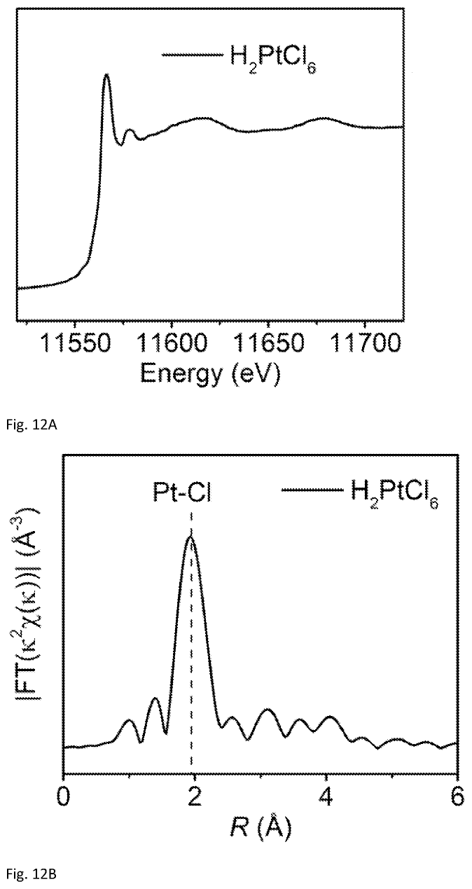

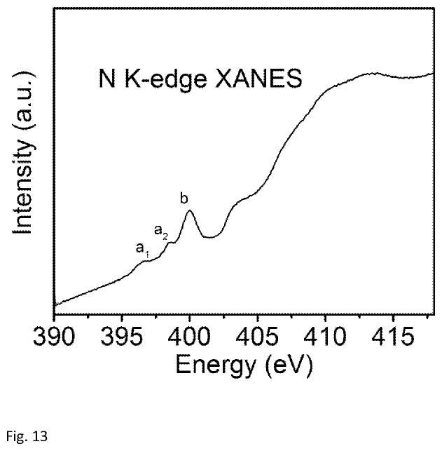

More importantly, Pt—N coordination can be confirmed by N K-edge XANES results. As shown in FIG. 13, the pyridinic peak is split into two peaks (a₁ and a₂), where a₂ is derived from a portion of pyridinic N bonded to Pt atoms, in accordance with the previous reports.^{[A43,44]}

### Method of Manufacture of the Catalyst

In another related aspect of the invention, there is provided a method of manufacturing a single-atom catalyst of the invention comprises nanostructures of a conductive material and a plurality of single-atom metal sites uniformly dispersed on the surface of each of the nanofibers, wherein each single-atom metal site comprises (preferably consists of) a single atom of each of one or more metal adsorbed on the surface of one of the nanofibers, and wherein the single-atom metal sites contain the same metal(s) or different metals.

In embodiments, the nanostructures are subnano-clusters, nanoparticles, nanorods, nanowires, nanosheets, nanocubes, nanospheres, nanoflowers, or nanofibers, preferably nanofibers.

In preferred embodiments, the method is a method of manufacturing the above catalyst.

This method allows producing catalysts with the above mentioned good catalytic activity for HER, while drastically reducing noble metal usage. Even more interestingly, this method is useful to produce single-atom catalysts containing various metals useful for various purposes. Hence, this method is a universal strategy that opens up a new avenue for the design of atomically dispersed metal sites supported on conducting materials. The method of the invention is a simple, facile, fast and in-situ strategy to synthesize a series of atomically dispersed metal sites including Pt, Ru and Pd on e.g., polyamine (PANI) nanofibers. Finally, the absence of any other chemical reducing agent or surfactant when creating the single-atom metal sites in the method of the invention results in a clean surface, offering maximum exposure of active sites.

The method of the invention comprises the steps of:
STEP A. providing a conductive substrate,
STEP B. electrodepositing nanostructures of a conductive material on the substrate or drop-casting a suspension of the nanostructures of a conductive material on the substrate, wherein said nanostructures have a negative surface charge,
STEP C. adsorbing one or more complex ions on the surface of the nanostructures, each complex ion comprising a single atom of each of one or more metal and having a total negative charge, and
STEP D. electrochemically reducing the metal(s), thereby producing the catalyst.

In this method, the conductive substrate, the conductive material, the nanofibers, and the metals are as described in the previous sections, including the preferred embodiments thereof.

In preferred embodiment, the conductive substrate is carbon cloth.

### Step B

In embodiments, step B comprises drop-casting a suspension of the nanostructures of a conductive material on the substrate. Preferably, step B comprises preparing a suspension of the nanostructure in a volatile solvent, such as ethanol, drop-casting the suspension on the substrate, and allowing the solvent to evaporate.

In alternative and preferred embodiments, step B comprises electrodepositing nanostructures of a conductive material on the substrate. Preferably, step B comprises electrodepositing the nanofibers using a three-electrode assembly comprising an electrolyte, the conductive substrate as a working electrode, a graphite electrode as a counter electrode, and an Ag/AgCl electrode as the reference electrode.

In preferred embodiments, a potential of about 0.6 to about 1.2 V vs. Ag/AgCl, preferably about 0.7 to about 0.9 V vs. Ag/AgCl is applied to the working electrode for a period of about 1 min to about 60 min, preferably about 5 to about 30 minutes.

In preferred embodiments, the electrolyte comprises the conductive material or a monomer of the conductive materiel.

Preferably, the conductive material is polyaniline, and the electrolyte comprises aniline. In preferred embodiments, the electrolyte comprises about 1 to about 10 v/v %, preferably about 2 to about 5 v/v % of aniline, based on the totally volume of the electrolyte.

In preferred embodiments, the electrolyte further comprises an acid. Preferably, the acid is HCl, HNO₃, H₂SO₄, HClO₄, or phytic acid, preferably HCl. In preferred embodiments, the electrolyte comprises between about 1 to about 20 v/v %, preferably between about 4 to about 10 v/v % of the acid, based on the totally volume of the electrolyte.

This step advantageous yields rough nanofibers as described above.

In embodiment, the method further comprises the step of washing, and then preferably drying, the conductive substrate with the electrodeposited nanofibers. In embodiments, water is used for said washing. In embodiments, the drying is at 60-100° C.

### Step C

In embodiments, step B comprises immersing the conductive substrate with the electrodeposited nanofibers in a solution comprising the above-mentioned complex ions, and allowing the complex ions to adsorb on the surface of the electrodeposited nanofibers.

As well known in the art, “complex ions” are ions comprising one or more ligands attached to a central metal cation (often a transition metal)—more rarely to two or more central metal cations—with a dative bond. It can be said that a complex ion is the charged version of a coordination complex. Also, a “ligand” is a species which can use its lone pair of electrons to form a dative covalent bond with a transition metal.

In the method of the invention, the complex ions comprise a single atom of each of one or more metal, preferably a single atom of one metal, this would be the abovementioned central metal cation. This single atom of the metal is attached to one or more ligands. Also, as noted above, the complex ions have a total negative charge. Thus, it can be said that these complex ions are of formula:

[M^{x+}(ligand)_{y}]^{z-},
wherein:
M represents a single atom of each of one or more metal with a total positive charge x of 1 or more,
(ligand)_{y} represents one or more ligand with a total negative charge >x, and
wherein x, y and z are integers >0.

The ligands in the complex ion can be identical to one another or the complex ion can comprise two or more different ligands. It will be apparent to the skilled person that since the complex ion has a total negative charge and the single atom(s) of the metal(s) bear(s) a positive charge, at least some of the ligands in the complex ion must be negatively charged.

In preferred embodiments, all the ligands are the same and are negatively charged.

Non-limiting examples of ligands are F⁻, H₂O, NH₃, Cl⁻, SCN⁻, and CN⁻, preferably Cl⁻.

Non-limiting examples of complex ions include: FeF₆³⁻, Co(SCN)₄²⁻, Cr(CN)₆³⁻, Co(CN)₆³⁻, Fe(CN)₆³⁻, Ni(CN)₄²⁻, [Cu(NH₃)Cl₅]³⁻, [CuCl₃(H₂O)]⁻, RuCl₆²⁻, AuCl₄⁻, IrCl₆²⁻, PtCl₆²⁻, and PdCl₄²⁻.

To make a catalyst in which all the single-atom metal sites comprise a single atom of a same metal, complex ions comprising a single atom of a single metal can be used. When all the metal sites comprise a single atom of each of two metals, complex ions comprising a single atom of each of two metals can be used or complex ions comprising a single atom of each of two metals can be used, etc. To make a catalyst comprising different metal sites, a combination of complex ions is used, each complex ion comprising the metal(s) to be found at each metal site.

In embodiments, step C further comprises the step of preparing the solution comprising the complex ions by adding a compound comprising the complex ion to a solvent. Preferred solvents include methanol, alcohol and water, preferably water, more preferably deionized water. The compound comprising the complex ion can be an acid or a salt. The acid would be of formula:

H_{z}[Mₓ₊(ligand)_{y}]^{z-}

while the salt would be of formula:

C_{w}[M^{x+}(ligand)y]^{z-}

wherein C_{w} represent one or more cation with a total charge of z+.

In embodiments, the method further comprises between step C and D, the step of washing, and then drying the conductive substrate after the complex ions have adsorbed on the surface of the nanostructures. In embodiments, water is used for said washing.

### Step D

In embodiments, step D comprises electrochemically reducing the metal(s) using one linear sweep voltammetry (LSV) scan.

In this step, the voltage is scanned from an upper limit to a lower limit, preferably from about 0.2 to about −1.0 V, preferably from about 0 to about −0.8 V, and most preferably from about 0 to about −0.5 V.

In preferred embodiments, a scan rate of about 0.1 to about 200 mV s⁻¹, preferably of about 1 to about 5 mV s⁻¹ is used.

In preferred embodiments, the electrolyte is an acidic, neutral, or alkaline aqueous solution, preferably a solution of H₂SO₄, HClO₄, KOH, or NaOH, phosphoric acid buffer, and most preferably a solution of H₂SO₄.

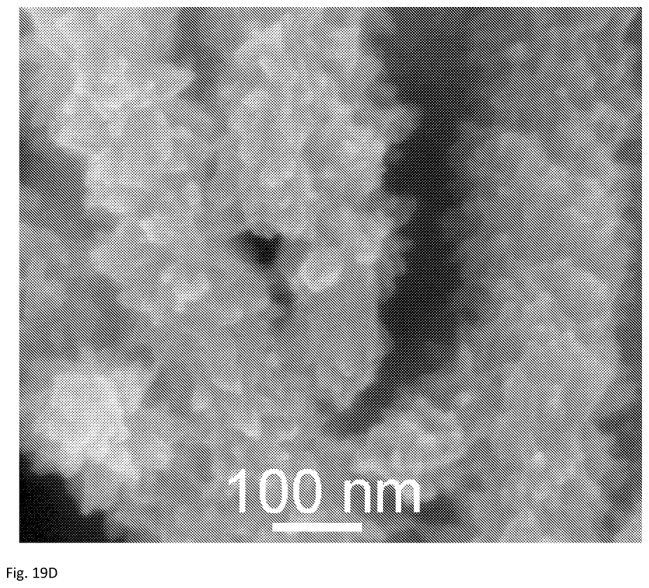

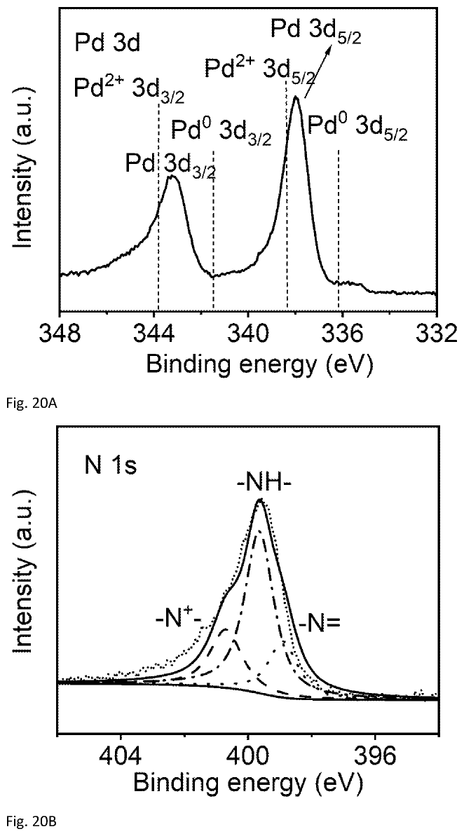

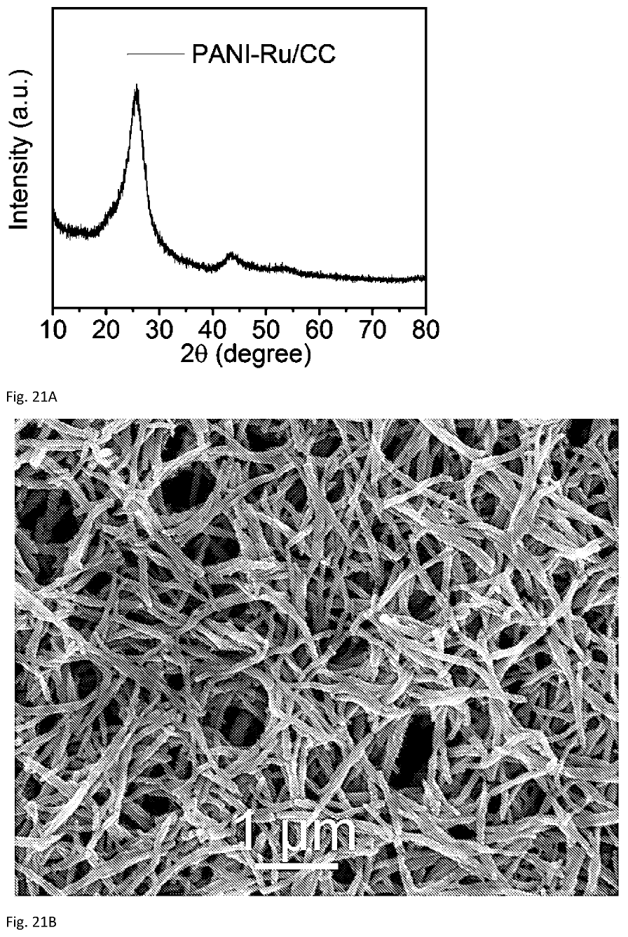

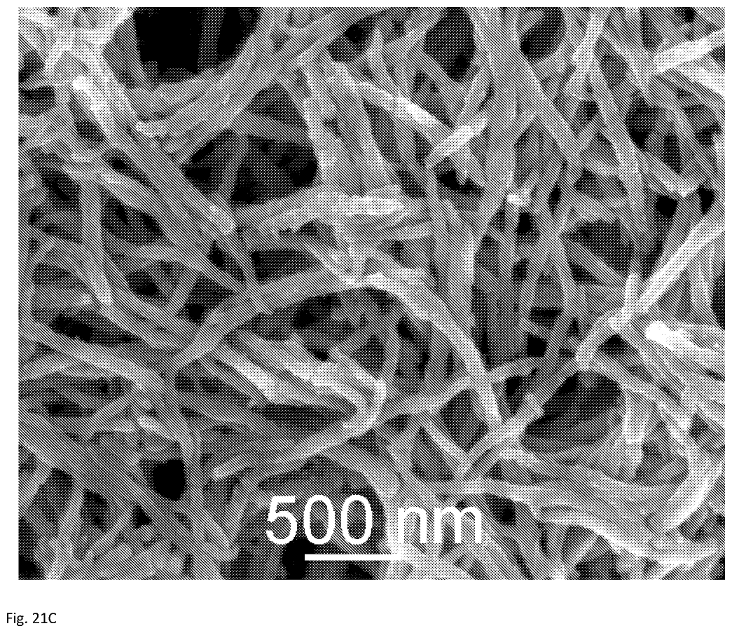

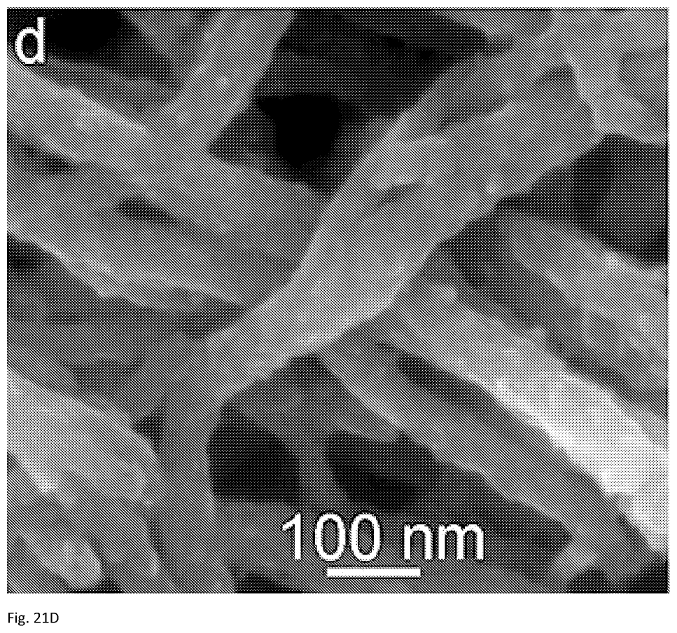

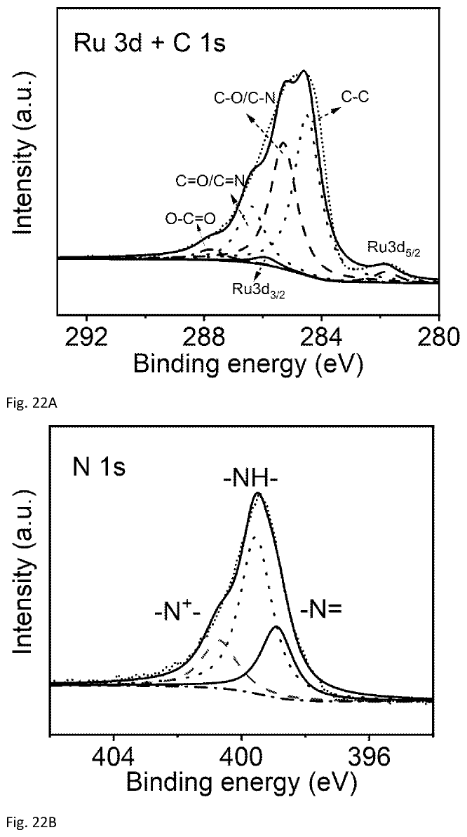

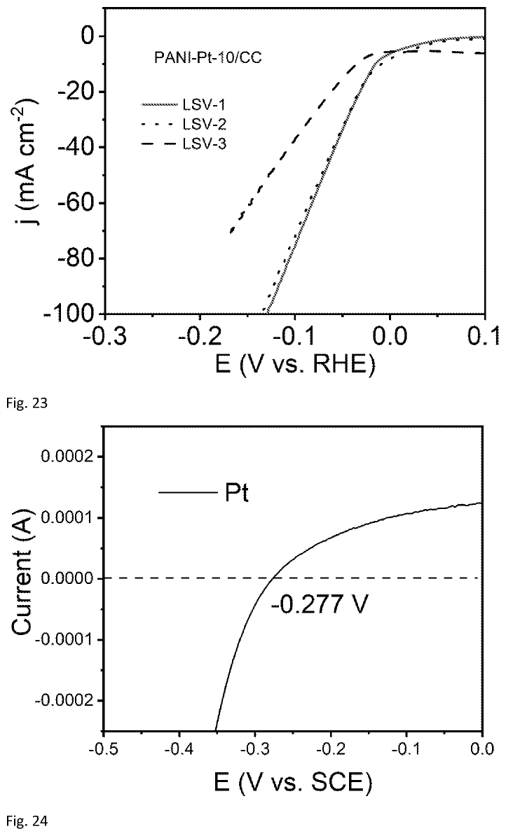

In conclusion, a preferred method of the invention, as described above, has the following advantages:
(1) The maximum protonation of PANI nanofibers result in maximum loading of negatively charged PtCl₆²⁻ ions by adsorption and an electrostatic self-assembly strategy,^{[A39,45]} and thus the redundant metal ion cannot be anchored, which can avoid the formation of metal clusters and nanoparticles in a subsequent reduction process;
(2) the in-situ electrochemical reduction is a facile, simple and fast (only requires one LSV scan, FIG. 23) preparation strategy without extreme conditions such as high temperature or high pressure, which, in turn, effectively avoids the agglomeration of the atomically dispersed metal atoms.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—In-situ Electrochemical Synthesis of Atomically Dispersed Metal Sites for Efficient Hydrogen Evolution Reaction

For hydrogen evolution reaction (HER), the development of efficient and robust non-Pt and low-Pt catalysts with equivalent or even superior performance to commercial Pt-based catalysts are highly desired, yet remains a grand challenge.

Herein, we report a facile and fast in-situ electrochemical strategy to synthesize atomically dispersed metal sites including platinum (Pt), ruthenium (Ru) and palladium (Pd) on the surface of polyaniline (PANI) supported on carbon cloth (PANI-M/CC).

Indeed, catalytic materials are stabilized onto certain substrates in order to adequately expose their active sites. PANI not only possesses high electrochemical conductivity but also can effectively capture the H⁺ from hydronium ions to form protonated amine groups that can be electro-reduced easily on atomically dispersed metal sites. Conducting polymers such as PANI is easily prepared in an aqueous medium. Particularly, it is chemically stable and highly conductive in acidic media. More importantly, PANI can effectively capture protons from solutions to form protonated amine groups, which can subsequently be electro-reduced easily to generate H₂ during the HER process.^{[A35]}

As an example, the atomically dispersed Pt sites anchored on carbon cloth supported PANI (PANI-Pt/CC) exhibited superior activity and stability toward HER. In fact, the mass activity of PANI-Pt-10/CC reached 25 Å mg_{Pt}⁻¹, which is a nearly 50-fold increase over the mass activity of the commercial 20 wt % Pt/C catalyst, and a much lower overpotential.

We attribute this outstanding performance to the following features:
(1) the high electrical conducting properties of PANI provide a low ohmic drop of electron transfer between the catalyst and electrolyte;
(2) PANI possesses abundant lone electrons on N atoms, which can easily capture H⁺ from solutions and thus eliminate the effect of coordinating water molecules around H⁺ to benefit HER;^{[A36]} and
(3) the atomically dispersed metal sites can expose their active sites maximumly.

This work provides a universal strategy to design atomically dispersed metal sites/conducting polymer heterostructures for highly efficient catalysts toward HER and beyond.

### Experimental Details

### Materials

All the chemicals were purchased from Sigma-Aldrich® (AR grade) and were used as received without further purification. Aniline, H₂PtCl₆·H₂O, (NH₄)₂PdCl₄, (NH₄)₂RuCl₆, HClO₄, HNO₃, HCl, Nafion® (5 wt %) and Pt/C (20 wt %) were all purchased from Sigma-Aldrich®. Ultrapure deionized water (DI Water, 18 MO cm-1) supplied by a Millipore® system.

### Preparation of Carbon Cloth (CC)

CC was cleaned with mixed aqueous solutions of HCl (19 wt. %) and HNO₃ (10 wt. %), followed by washing with deionized water repeatedly.

### Synthesis of Catalysts

PANI was prepared by electrodeposition using a three-electrode configuration with CC (1×5 cm²), graphite plate and Ag/AgCl as the working electrode, the counter electrode and the reference electrode, respectively. The electrolyte was prepared by dissolving 8.0 mL HCl in 88 mL H₂O and then adding 4.0 mL aniline to form a uniform solution after stirring for half an hour. A constant potential of 0.8 V vs. Ag/AgCl was applied to the CC electrode for 10 min.

After that, PANI/CC was washed with water, followed by drying at 80° C. for 1 h and then immersed in different concentrations of H₂PtCl₆·H₂O solution for 4 h. The H₂PtCl₆·H₂O solutions were prepared using 5, 10, 20 and 30 mg H₂PtCl₆·H₂O in 20 mL of deionized water. Next, excess solution was removed and the PANI-H₂PtCl₆/CC hybrid was dried.

Finally, the as-prepared PANI-Pt-5/CC, PANI-Pt-10/CC, PANI-Pt-20/CC, and PANI-Pt-30/CC was prepared by in-situ electrochemical reduction. The reduction process was conducted with one linear sweep voltammetry (LSV) scan in 0.5 M H₂SO₄ solutions at a scan rate of 2 mV s⁻¹.

Note that the PANI-Ru/CC and PANI-Pd/CC were also made under the same condition except replacing H₂PtCl₆·H₂O with (NH₄)₂RuCl₆ or (NH₄)₂PdCl₄, respectively.

### Characterizations

X-ray powder diffraction (XRD) patterns were collected on a Rigaku X-ray diffractometer equipped with a Cu K_{α} radiation source.

Scanning electron microscopy (SEM) measurements were carried out on a XL30 ESEM FEG scanning electron microscope at an accelerating voltage of 20 kV.

Transmission electron microscopy (TEM) measurements were performed on a HITACHI H-8100 electron microscopy (Hitachi, Tokyo, Japan) with an accelerating voltage of 200 kV.

X-ray photoelectron spectroscopy (XPS) was obtained on an ESCALABMK II X-ray photoelectron spectrometer; the peak energies were calibrated by placing the principal C1s peak at 284.6 eV.

Element composition was analyzed by inductively coupled plasma optical emission spectroscopy (ICP-OES) on Prodigy 7 and ANALYZER(CHNSO) on Vario EL cube. The ICP-OES elemental analyses were performed to obtain the Pt, Ru and Pd amount in the samples.

The X-ray absorption near-edge structure data (Pt L3-edge) were collected on the 061D-1 Hard X-ray MicroAnalysis (HXMA) beamline at the Canadian Light Source (CLS, operated at 2.9 GeV with a maximum current 250 mA). Measurements were made at room temperature using a 32-element Ge detector. The XANES spectra at N K-edge were obtained at the spherical grating monochromator (SGM) beamline 11ID-1 with an energy resolution of E/ΔE≥5000. The spectra were recorded in partial X-ray fluorescence yield (PFY) mode using four silicon drift detectors (SDD) under 10⁻⁶ Torr with a beam spot size of 25 μm. Data were first normalized to the incident photon flux I₀ measured with a refreshed gold mesh at SGM before the measurement. The spectra were normalized with respect to the edge height after subtracting the pre-edge and post-edge backgrounds, and then the data was converted from energy space to k space using ATHENA software.

### Electrode Preparation and Electrochemical Measurements:

The HER electrochemical measurements were performed in a standard three-electrode with a two-compartment cell on an electrochemical workstation (CHI 760E). The acidic (0.5 M H₂SO₄) electrochemical measurements were performed using a saturated calomel electrode (SCE) as the reference electrode. A graphite plate was used as the counter electrode in all measurements. Polarization data were obtained at a scan rate of 2 mV s⁻¹. In all measurements, the reference electrode was calibrated with respect to the reversible hydrogen electrode (RHE). The calibration was performed in the high purity H₂-saturated electrolyte with a Pt electrode as the working electrode. The current-voltage was run at a scan rate of 2 mV s⁻¹, and the average of the two potentials at which the current crossed zero was taken to be the thermodynamic potential for the hydrogen electrode reactions. All polarization curves were iR-corrected. Electrochemical impedance spectroscopy (EIS) measurements were carried out in the frequency range of 100 kHz-0.1 Hz with an AC amplitude of 5 mV. The iR-corrected potential was obtained after the correction of internal resistance measured by EIS following the equation: E_{actual}=Eₜₑₛₜ−iR×100%, where Eₜₑₛₜ is the original potential, R is the internal resistance, i is the corresponding current, and E_{actual} is the iR-corrected potential.

### Commercial PVC Preparation

A commercial 20 wt % Pt/C catalyst ink was prepared by dispersing 5 mg catalyst in 990 μL mixed solution of isopropyl alcohol and water (volume ratio 5:5) and 10 μL 5 wt % Nafion® solutions. The mixed solutions were dispersed for 15 min by ultrasonic cell disruptor, and then 5 μL homogeneous catalyst ink was deposited on a glassy carbon electrode (diameter: 3.0 mm), the electrode was allowed to dry at room temperature for 15 min to form a smooth catalyst ring.

### Results and Discussion

### Fabrication

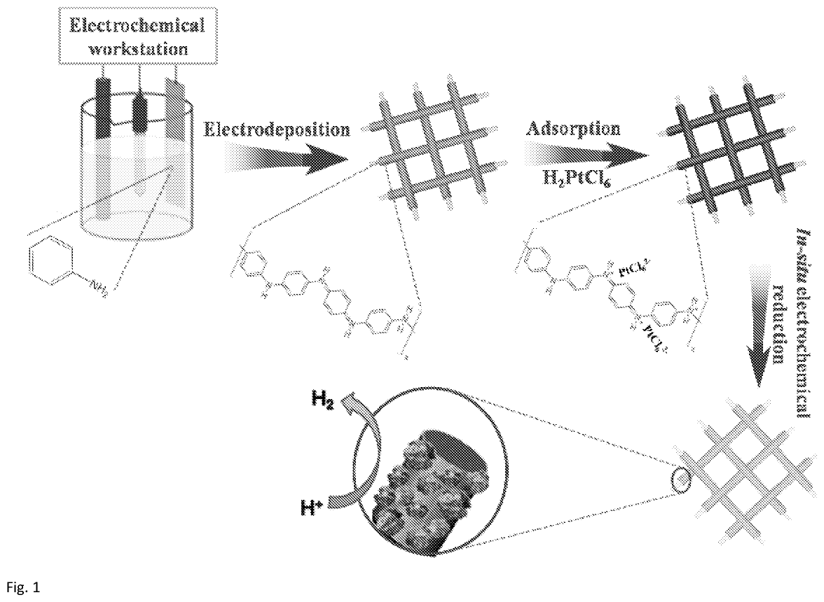

As illustrated in FIG. 1, the fabrication of PANI-Pt/CC materials includes three steps.

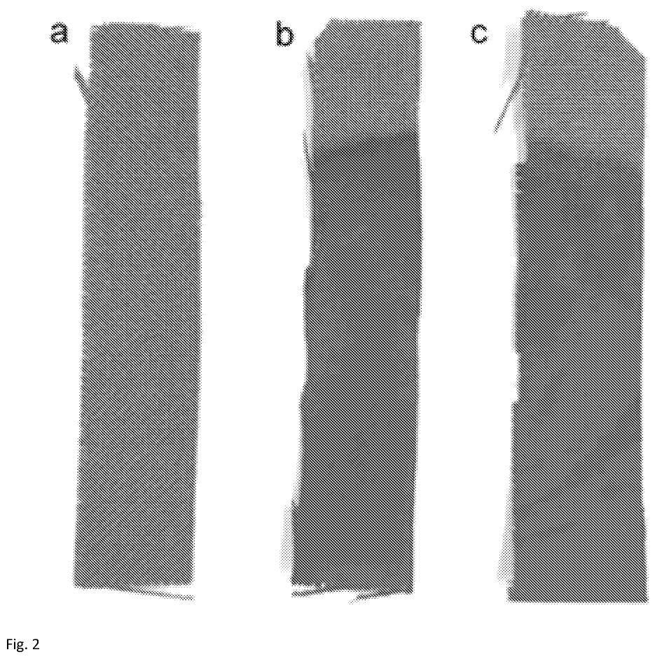

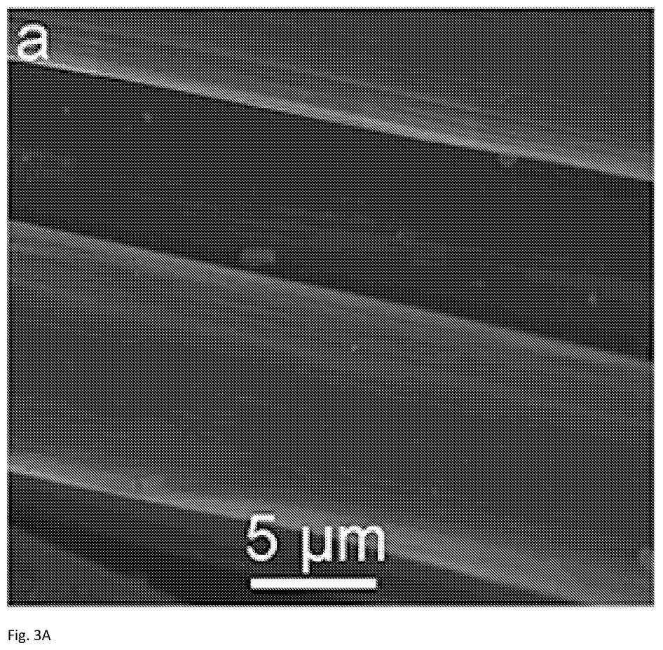

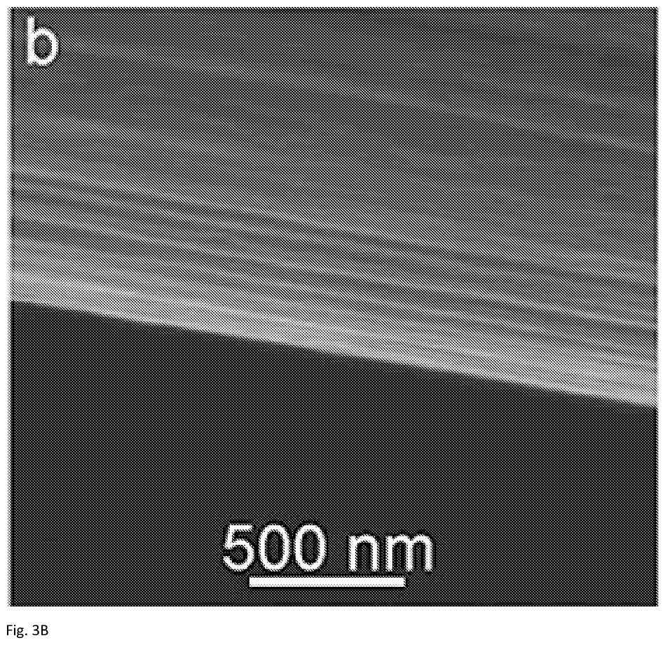

A smooth CC was used as a current collector and a substrate for PANI nanofibers growth (FIG. 2 and FIG. 3).

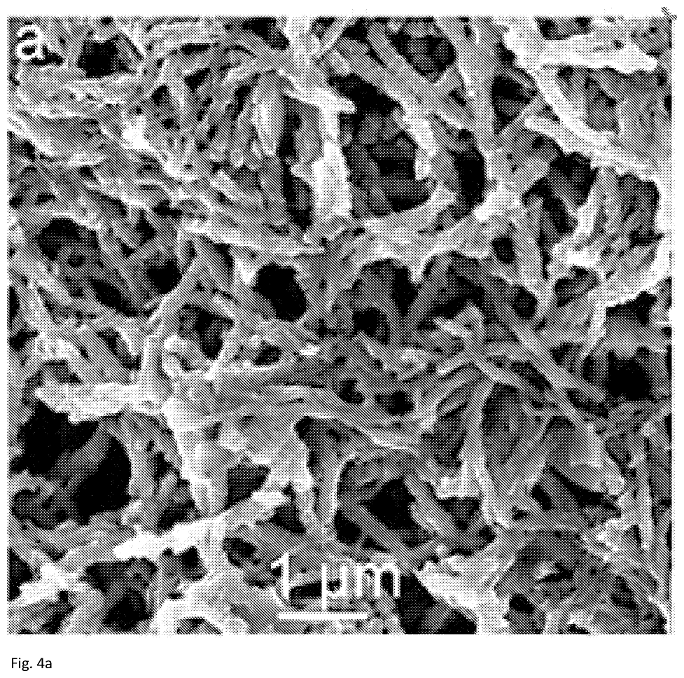

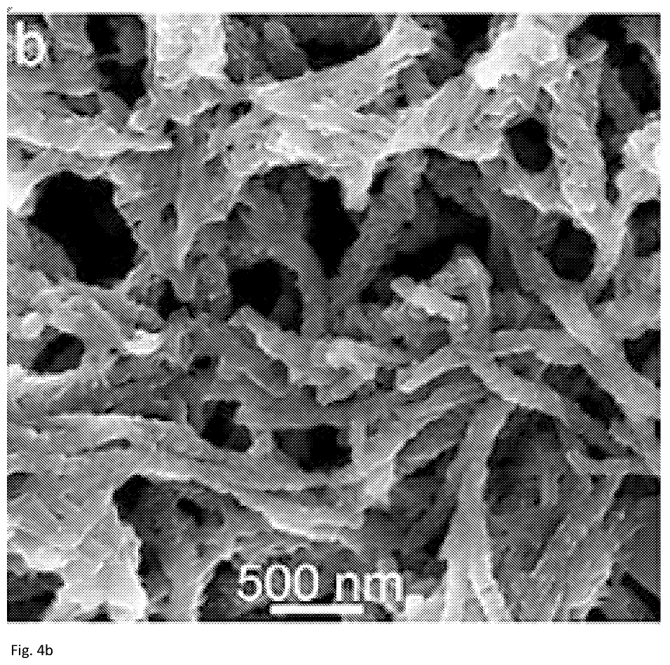

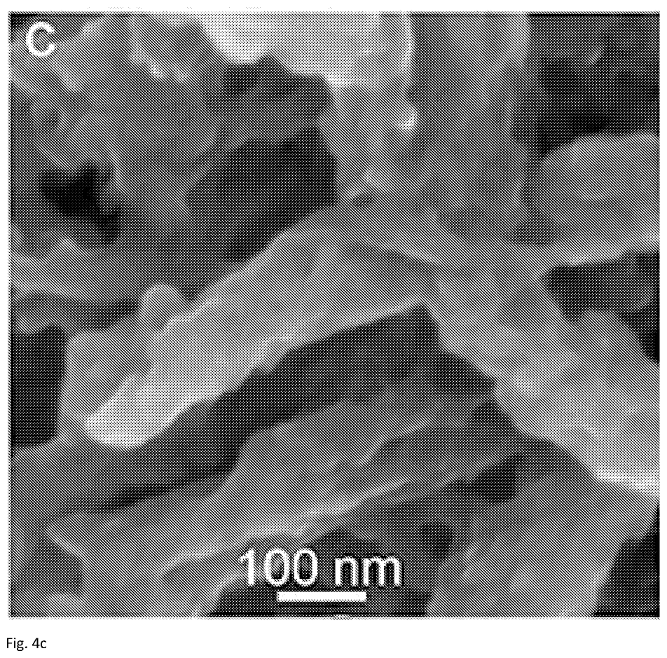

PANI nanofibers were first decorated on the bare CC substrate by electrochemical deposition in an acid aniline solution. As shown in FIG. 4, the surface of CC was covered uniformly by PANI nanofibers with diameters about 200 nm. In addition, the surfaces of the PANI nanofibers were very rough, which is beneficial for the absorption of the metal ions in the subsequent experimental step.

After that, the negatively charged PtCl₆²⁻ ions were adsorbed on the positively charged PANI nanofibers via a solution-phase electrostatic assembly and absorption.^{[A36]}

Finally, the adsorbed PtCl₆²⁻ ions were in-situ reduced into atomically dispersed Pt sites under a voltage where hydrogen evolution occurs. The reduction process was conducted with one LSV scan in 0.5 M H₂SO₄ solutions at a scan rate of 2 mV s⁻¹. It is worthwhile to mention that the absence of any other chemical reducing agent would result in a clean surface of the obtained single-atom catalysts (SACs) which offers maximum exposure of active sites.^{[A32]}

### Structure

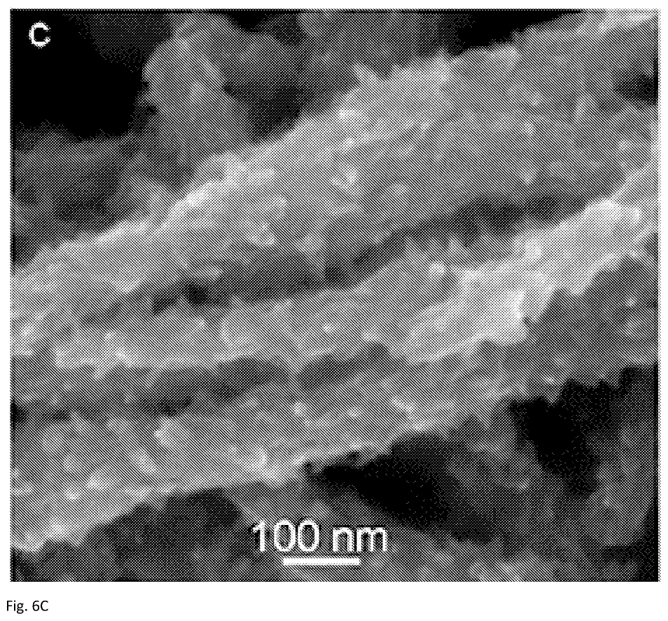

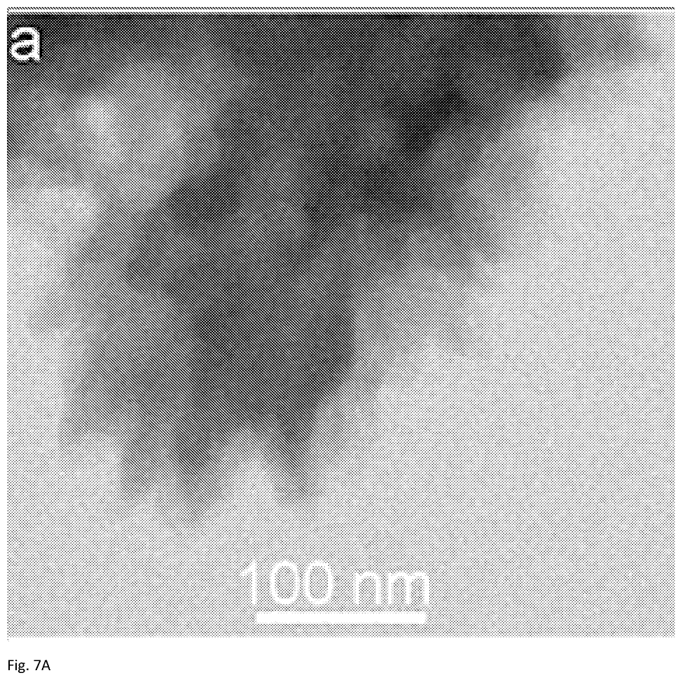

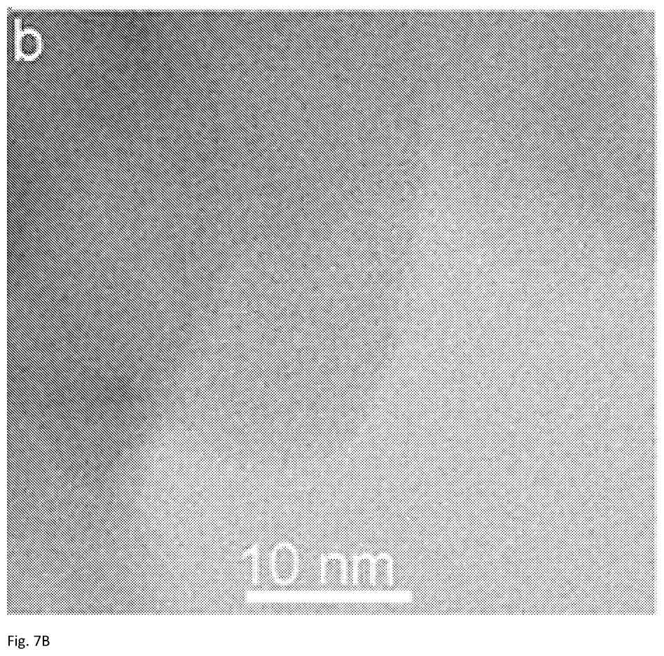

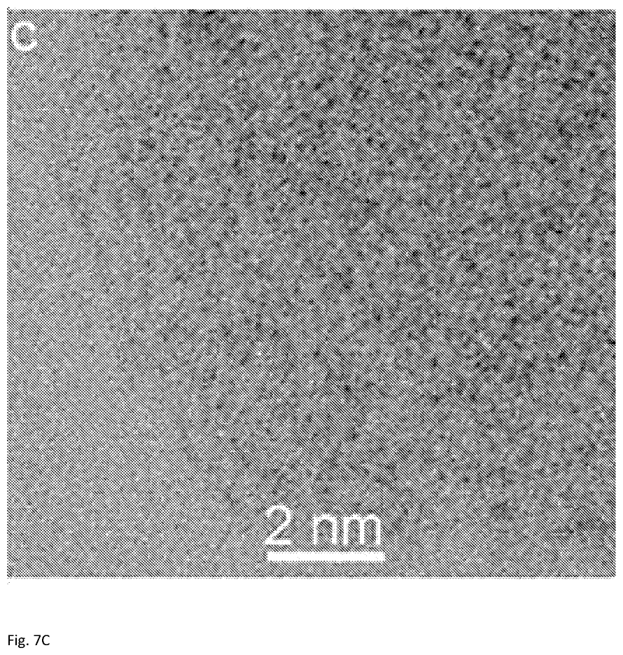

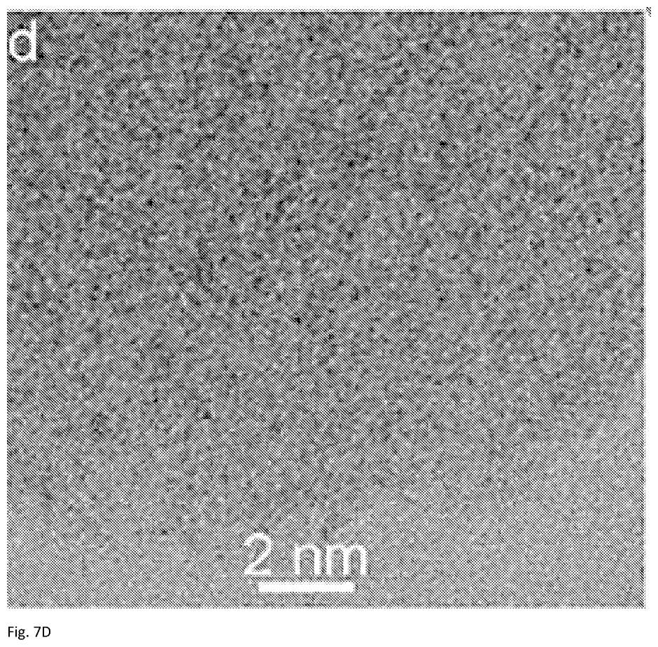

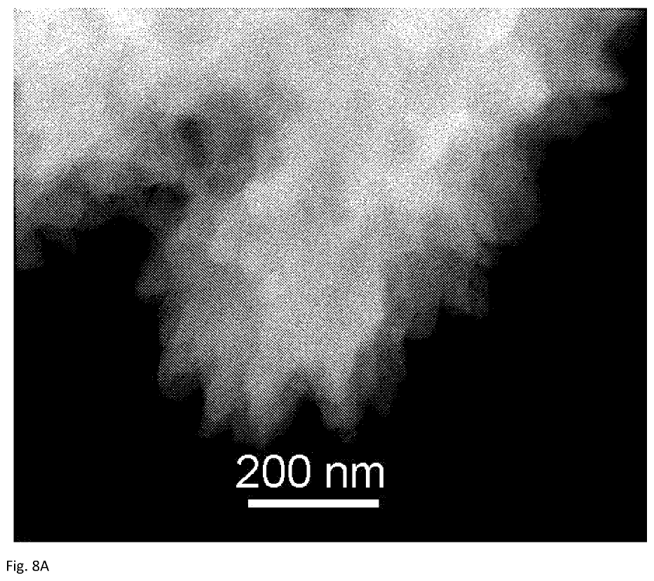

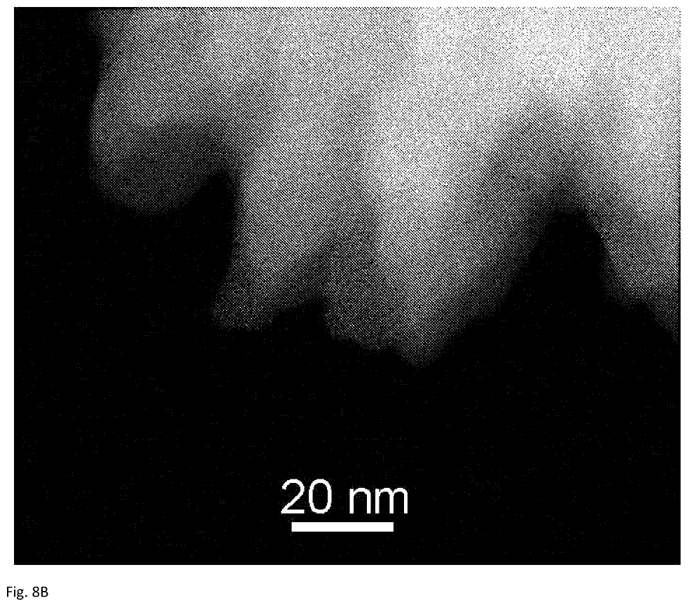

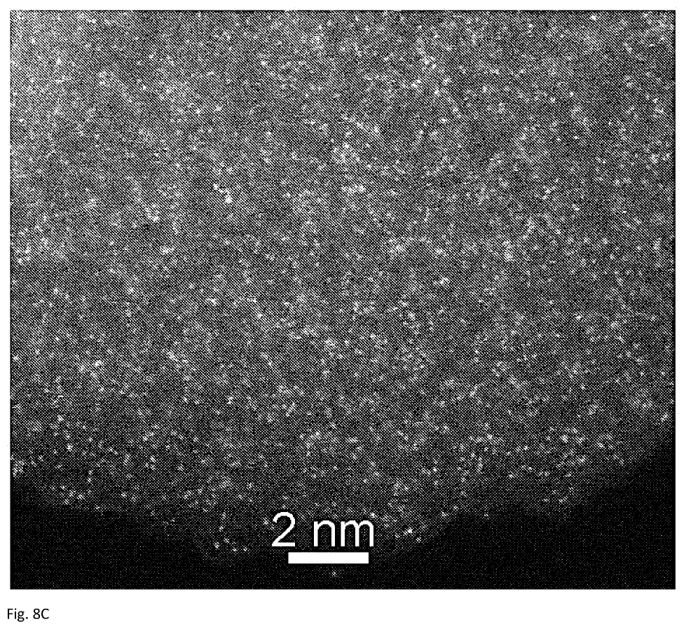

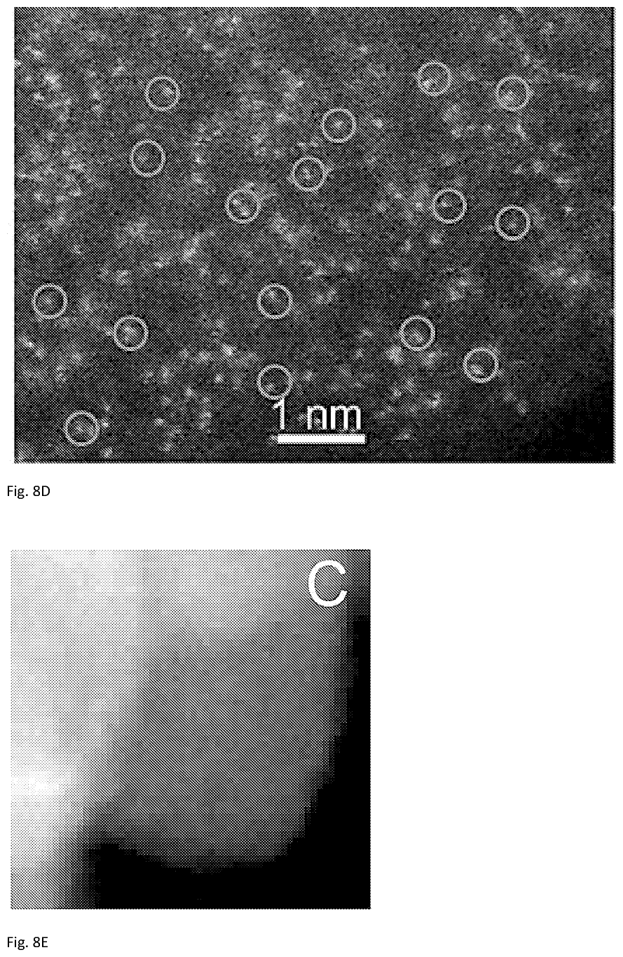

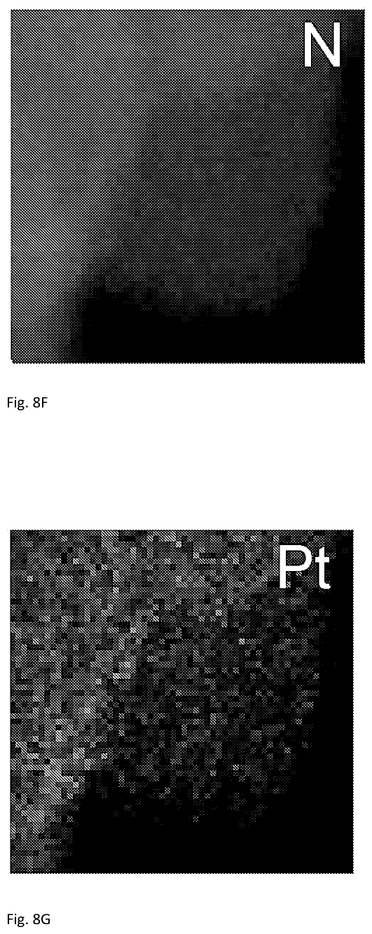

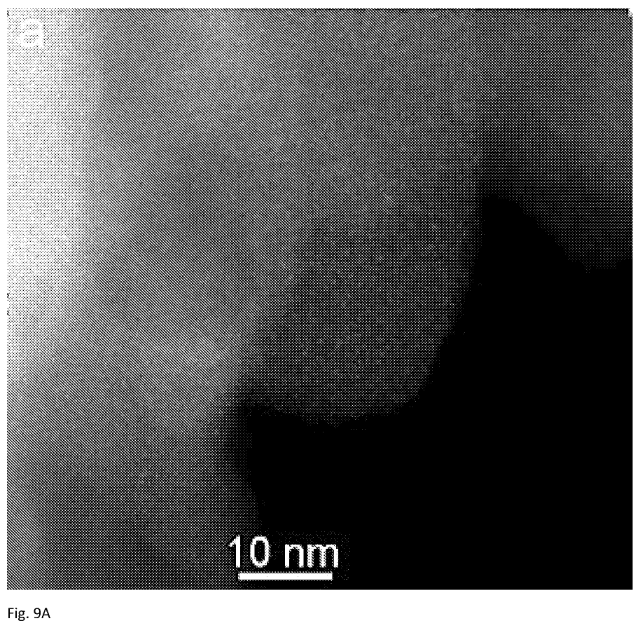

The structure of the obtained product was first studied by XRD. As shown in FIG. 5, no diffraction peaks related to Pt-based clusters or nanoparticles are observed in the XRD patterns of the PANI-Pt-10/CC (10 representatives 10 mg metal salt has been added in the experiment process). The morphology of the prepared sample was characterized by SEM. As demonstrated in FIG. 6, the low- and high-magnification SEM images show that the PANI-Pt-10/CC nanofibers are interconnected with each other, with an average diameter of 200 nm, forming a three-dimensional macroporous structure. The TEM and high-resolution TEM (HRTEM) images further show that there are no Pt-based nanoparticles or even clusters in the PANI-Pt-10/CC (FIG. 7). The scanning TEM (STEM) images shown in FIG. 8a and FIG. 8b indicate that the edge of a PANI-Pt-10 nanofiber is serrated; this phenomenon can enhance an active surface area of the materials, which is further beneficial for improving the catalytic activity.^{[A38]} The aberration-corrected high-angle annular dark-field STEM (AC-HAADF-STEM) images of PANI-Pt-10 further demonstrate that isolated Pt atoms are uniformly distributed on the PANI nanofiber (FIG. 9 and bright dots in FIG. 8c and FIG. 8d). The energy-dispersive X-ray (EDX) elemental mapping confirm that the N and Pt species are homogeneously dispersed on PANI nanofiber (FIG. 8e to FIG. 8g). The mass loadings of Pt for PANI-Pt-10/CC is measured to be 2.62 μg cm² by inductively coupled plasma optical emission spectroscopy (ICP-OES) (Table 1).

TABLE 1
The Pt/Ru/Pd content analyzed by ICP-OES.

| Catalyst | ICP (μg cm²) |
|---|---|
| PANI-Pt-5/CC | 1.24 |
| PANI-Pt-10/CC | 2.62 |
| Post-HER PANI-Pt-10/CC | 2.37 |
| PANI-Pt-20/CC | 2.82 |
| PANI-Pt-30/CC | 2.80 |
| Commercial Pt/C | 19.6 |
| PANI-Ru SAs/CC | 0.8 |
| PANI-Pd SAs/CC | 2.5 |

XPS was first conducted to investigate the chemical state of the Pt in PANI-Pt-10/CC. As shown in FIG. 10a, the Pt 4f XPS spectrum presents a single doublet (Pt 4f_{5/2} and Pt 4f_{7/2}) at 72.9 and 76.1 eV. Furthermore, the Pt 4f peaks are located between those of Pt⁴⁺ and Pt⁰, suggesting that the isolated Pt atoms in PANI-Pt-10/CC possess a more positive valence state than those of Pt nanoparticles. Such a partially charged state can be attributed to the strong interaction between Pt and the PANI molecules in the form of Pt—N ligand bonds.^{[A7′21-39]} The trace amounts of N are originated from —NH—, —N═, —N₊— of stacked polyaniline (FIG. 1a). The O 1s peak at 532.2 eV is ascribed to the adsorbed H₂O (FIG. 11b).^{[A40,41]} The electronic and local structure of PANI-Pt-10/CC was further investigated by X-ray absorption fine spectroscopy (XAFS). FIG. 10b shows the Pt L3-edge X-ray absorption near-edge structure (XANES) together with the Pt foil and PtO₂ as a comparison. The white-line (WL) intensity of PANI-Pt-10/CC is obviously lower than that of PtO₂ and is much higher than that of Pt foil, further indicating the oxidation state of Pt^{δ+} (4>δ⁺>0). More importantly, the positive valence state is calculated to be 2.0 (FIG. 10c) by fitting the WL intensity, confirming the oxidation state of Pt.^{[A42]} Furthermore, the Fourier transform extended X-ray absorption fine structure (FT-EXAFS) spectra of PANI-Pt-10/CC presents a peak at ˜1.8 Å (FIG. 10d), which can be attributed to the Pt—N bond, whereas no obvious Pt—Pt (˜2.7 Å, FIG. 10d) or Pt—Cl (˜1.95 Å, FIG. 12) peaks are detected in sharp contrast to Pt foil and H₂PtCl₆, respectively. These results demonstrating that Pt is atomically dispersed in the PANI nanofiber and anchored by the N atoms with the absence of Pt nanoparticles or clusters.^{[A24]} More importantly, Pt—N coordination can be confirmed by N K-edge XANES results. As shown in FIG. 13, the pyridinic peak is split into two peaks (a₁ and a₂), where a₂ is derived from a portion of pyridinic N bonded to Pt atoms, in accordance with the previous reports.^{[A43,44]}

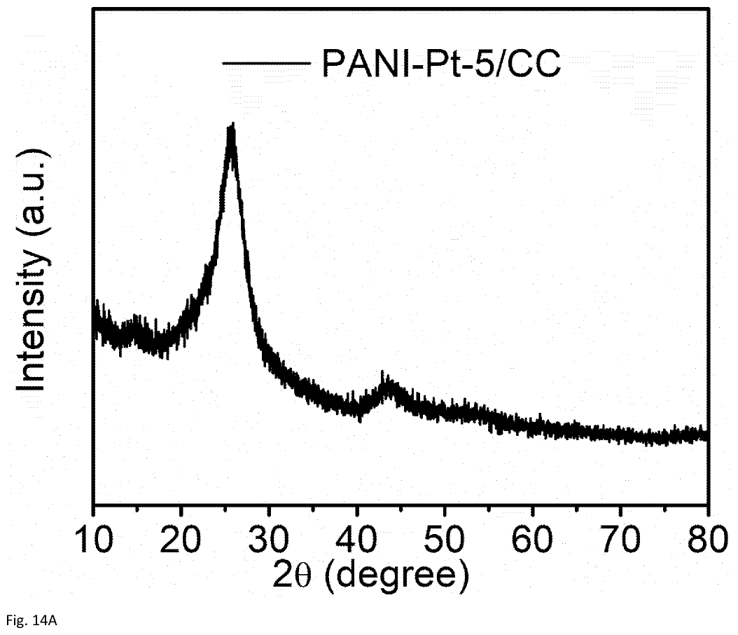

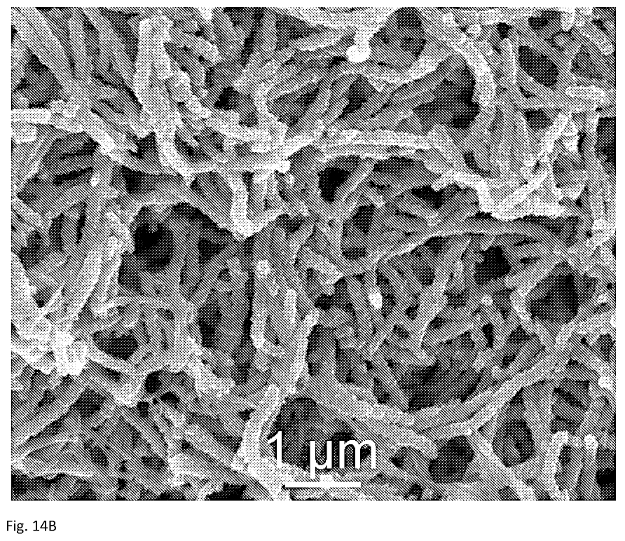

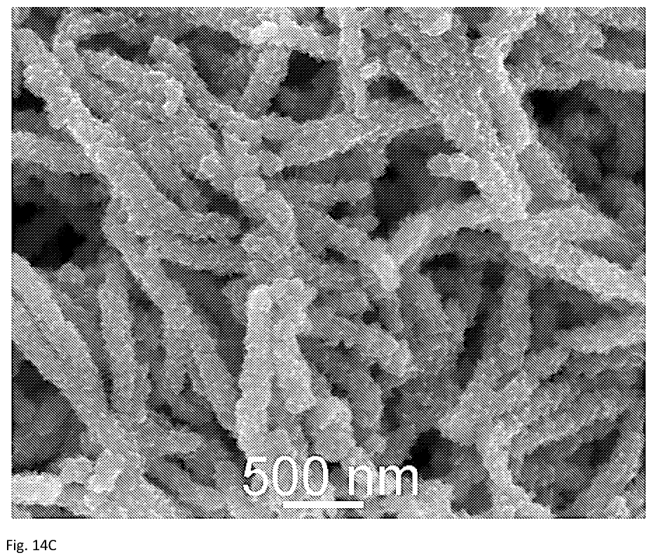

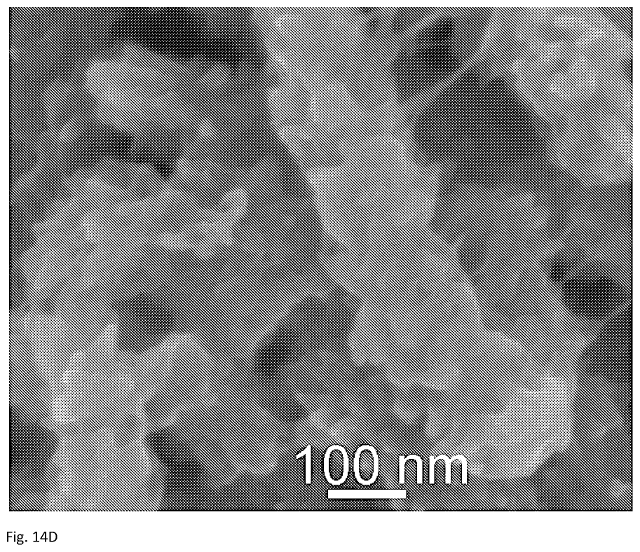

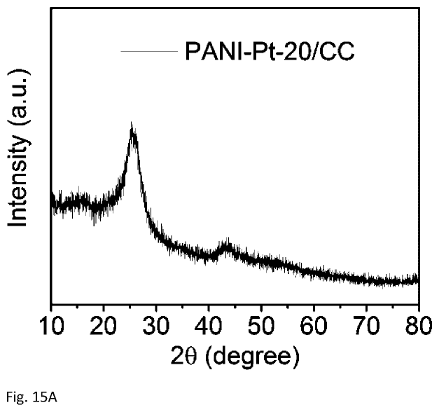

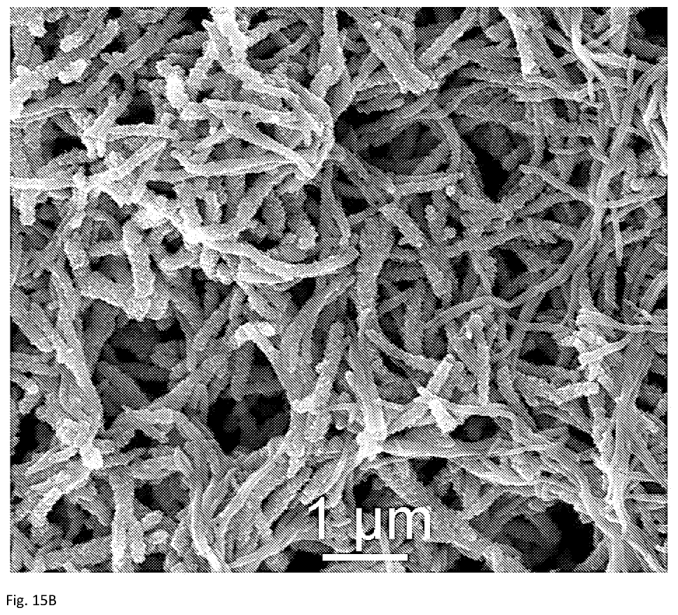

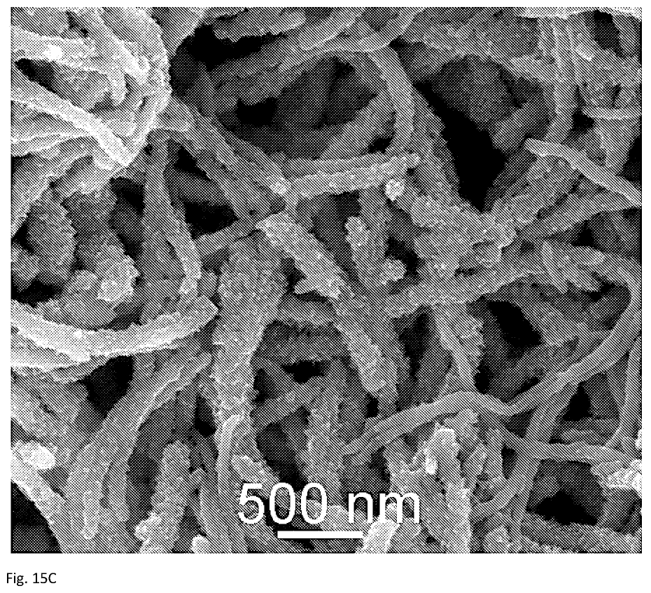

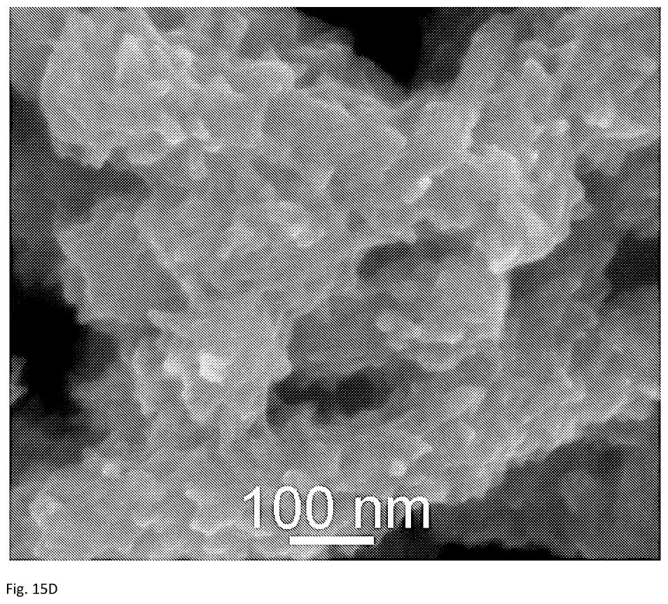

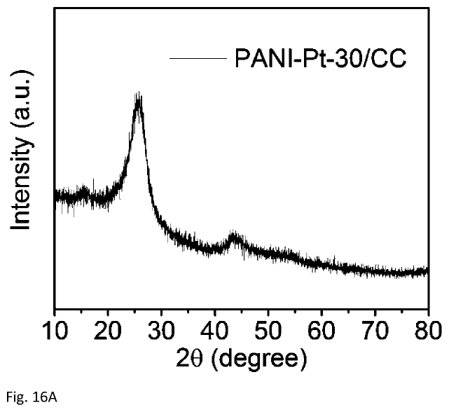

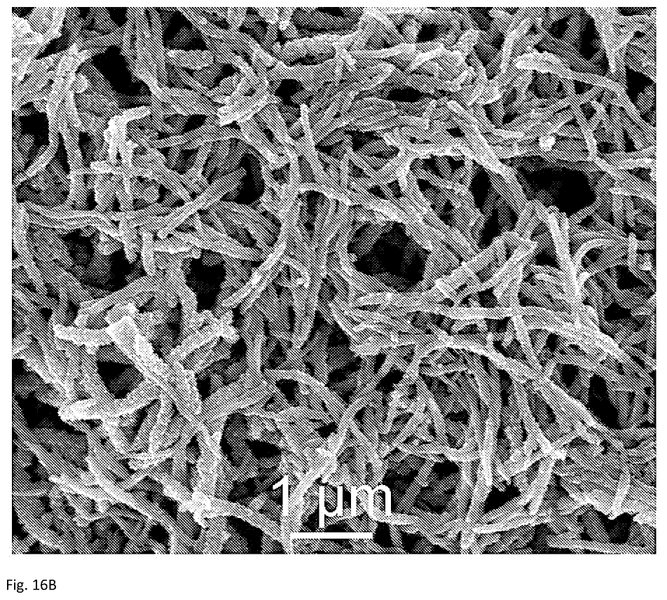

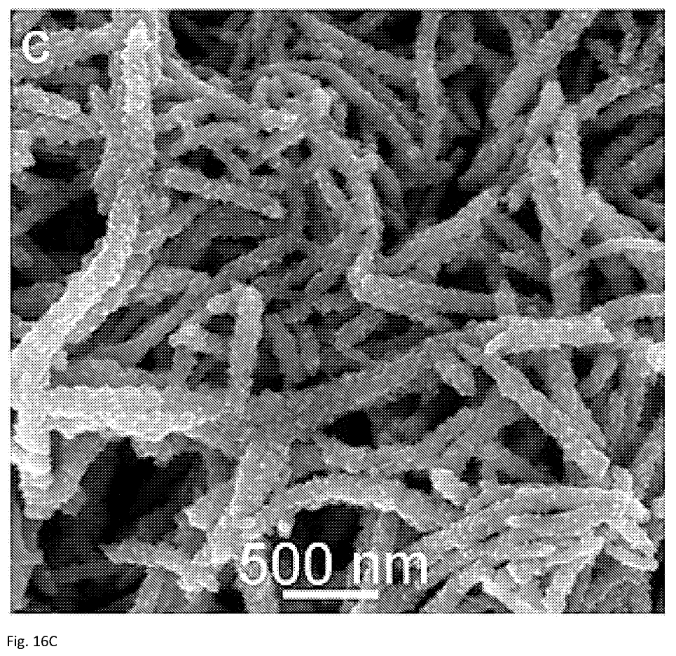

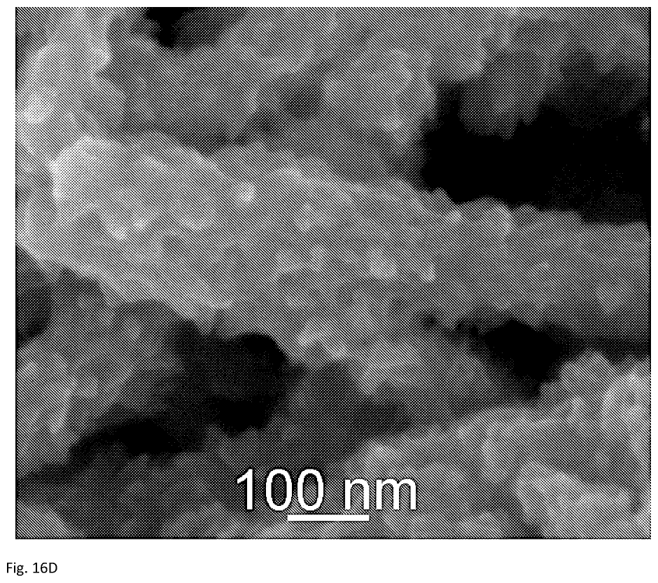

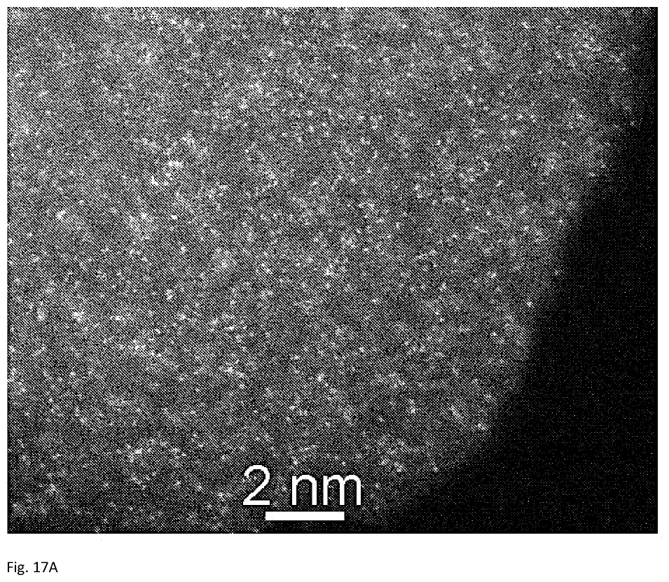

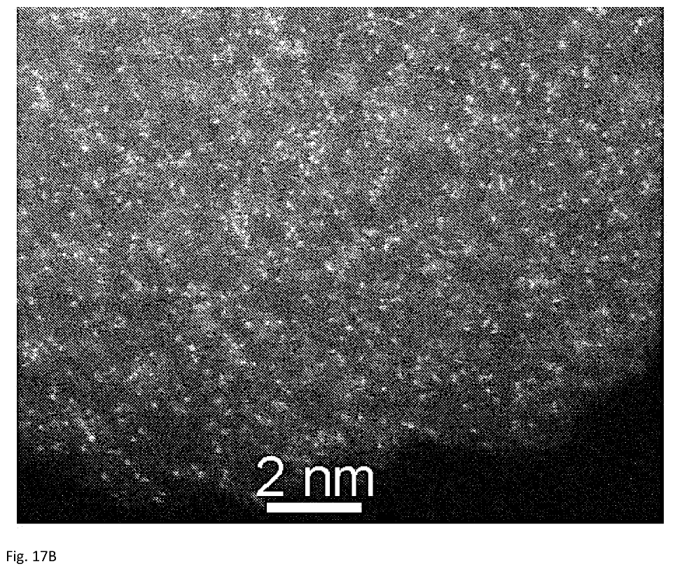

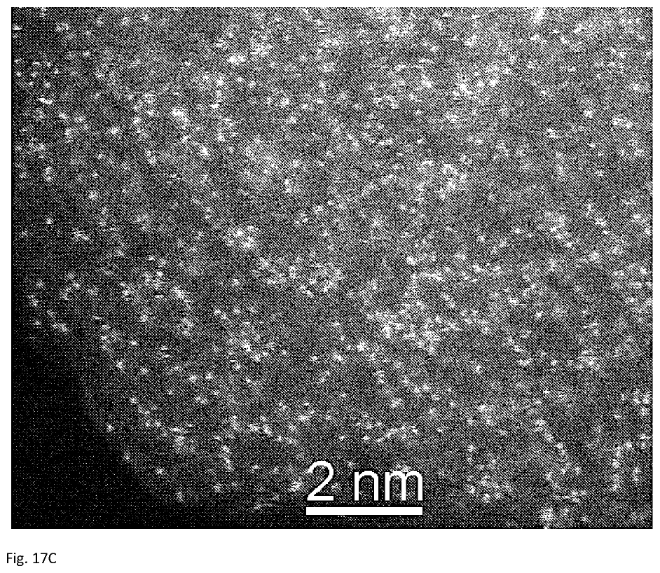

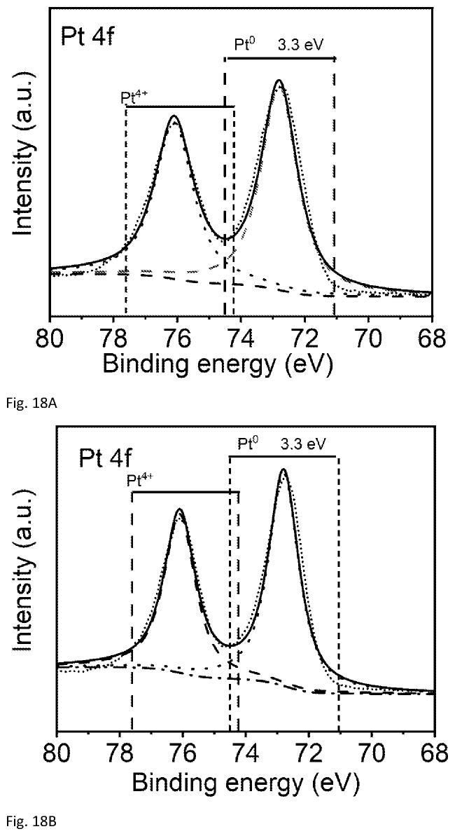

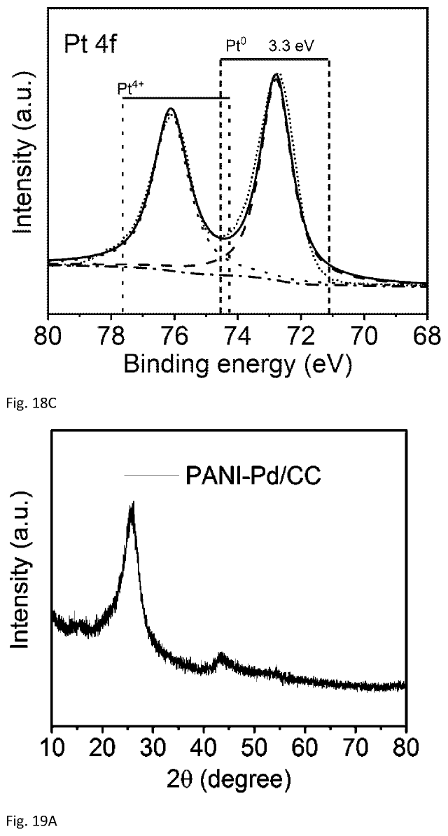

Additionally, a series of PANI-Pt/CC samples with atomically dispersed Pt sites anchored on PANI were obtained with several quantities (5, 20, and 30 mg) of H₂PtCl₆·H₂O. The loadings of Pt in these samples were measured via ICP-OES. As illustrated in Table 1, the Pt content is increased in a range between 1.24 to 2.82 μg cm-2 and then remained nearly constant even with a further addition of H₂PtCl₆·H₂O by 30 mg. The XRD patterns with SEM and AC-HAADF-STEM images (FIG. 14 to FIG. 17) further indicate that Pt in all obtained samples is atomically dispersed. Furthermore, as shown in FIG. 18, the Pt 4f peaks are located between those of Pt⁴⁺ and Pt⁰, suggesting that the isolated Pt atoms in PANI-Pt-5/CC, PANT-Pt-20/CC and PANT-Pt-30/CC possess a more positive valence state than those in Pt nanoparticles.

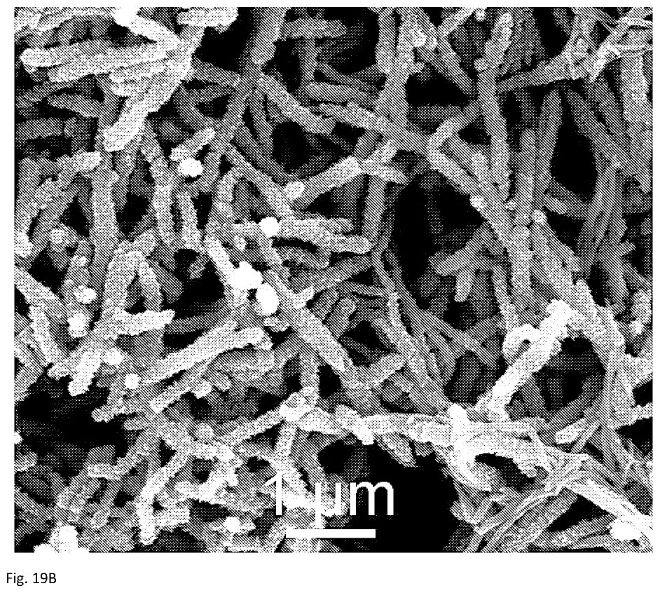

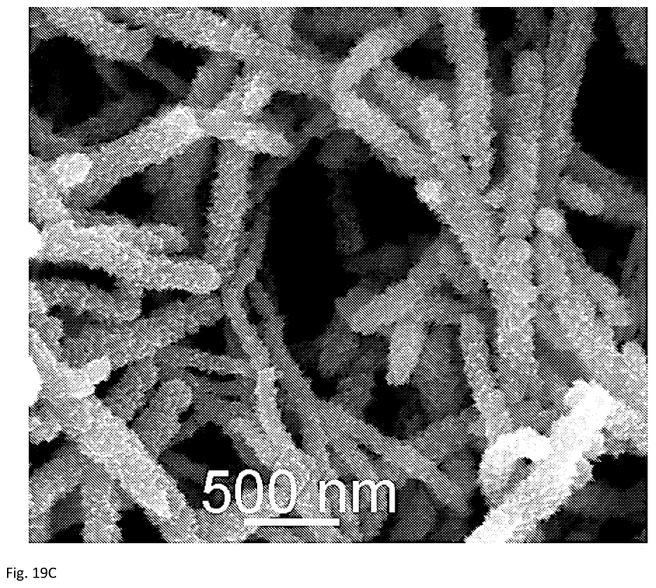

Importantly, this in-situ electrochemical strategy can be extended to synthesizing other atomically dispersed metal sites such as Pd and Ru (FIG. 19 to FIG. 22). Therefore, the developed strategy is a universal fabrication approach for atomically dispersing metal sites. This synthetic method has the following unique advantages: (1) The maximum protonation of PANI nanofibers result in maximum loading of negatively charged PtCl₆²⁻ ions by adsorption and an electrostatic self-assembly strategy,^{[A39,45]} and thus the redundant metal ion cannot be anchored, which can avoid the formation of metal clusters and nanoparticles in a subsequent reduction process; (2) the in-situ electrochemical reduction is a facile, simple and fast (only requires one LSV scan, FIG. 23) preparation strategy without extreme conditions such as high temperature or high pressure, which, in turn, effectively avoids the agglomeration of the atomically dispersed metal atoms.

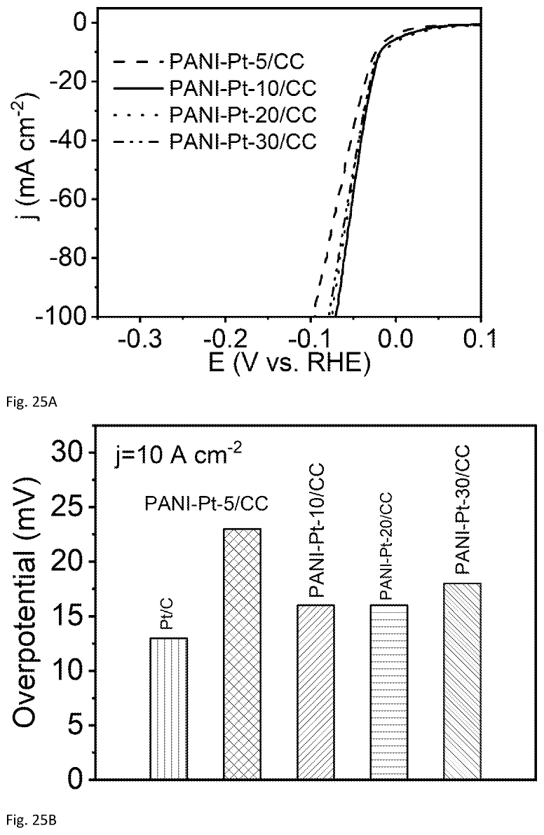

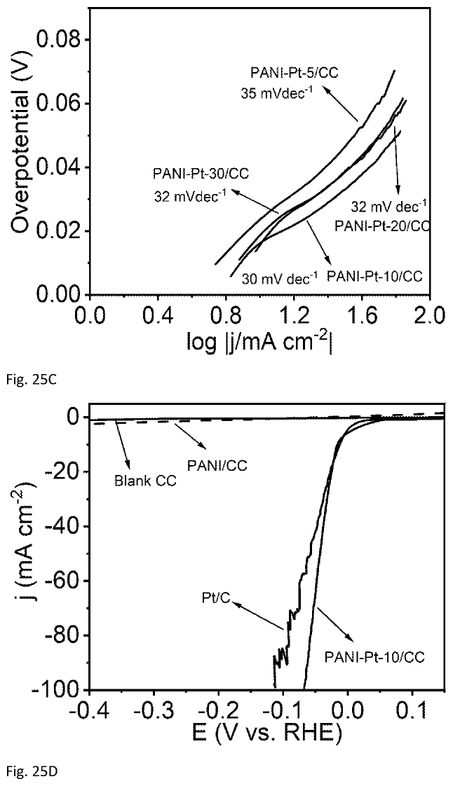

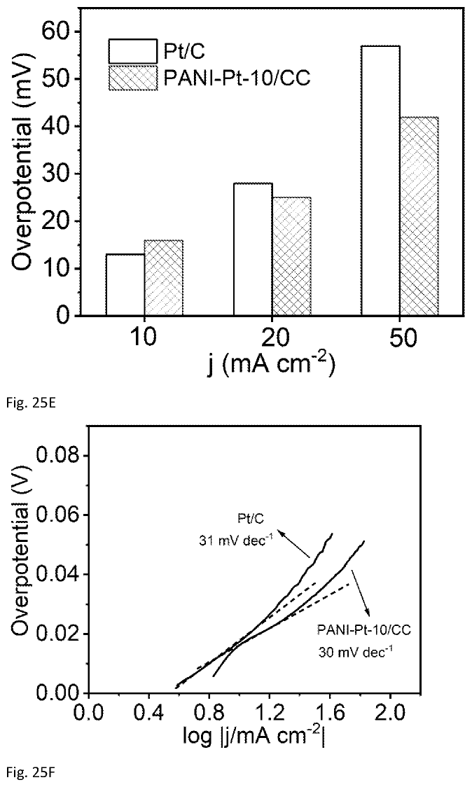

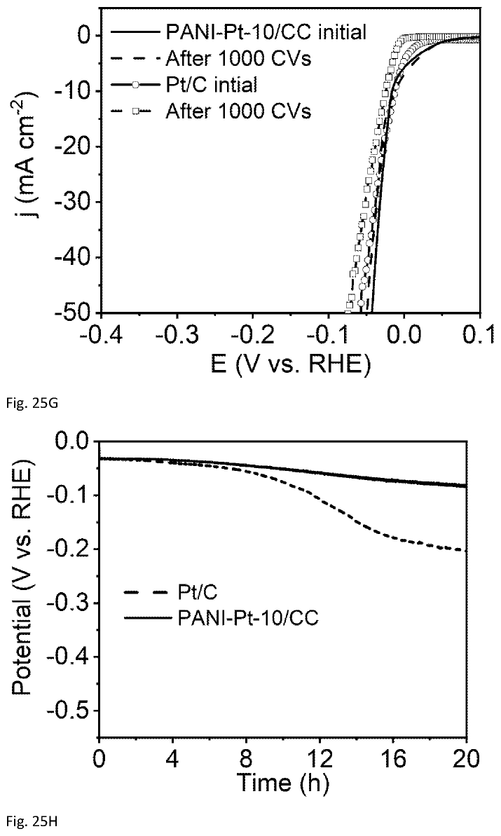

The electrocatalytic activity of the obtained atomically dispersed Pt samples was evaluated by LSV in H₂-saturated acid media (0.5 M H₂SO₄) with a scan rate of 2 mV s⁻¹ at room temperature. Before the tests, the SCE was calibrated in a high purity H₂-saturated 0.5 M H₂SO₄ solutions electrolyte with a Pt electrode as the working electrode (FIG. 24). As illustrated in FIG. 25a, the LSV curves indicate an increased HER activity when the weight of H₂PtCl₆·H₂O increased from 5 to 10 mg, whereas the activity tends to be nearly unchanged when further increasing the quantity of H₂PtCl₆·H₂O to 30 mg. This indicates that the adsorption of negatively charged PtCl₆²⁻ ions on PANI nanofibers has been saturated at 10 mg of H₂PtCl₆·H₂O,^{[A39,41,45]} and thus the excess PtCl₆²⁻ ions cannot be anchored even when further increasing the amount of Pt precursors.

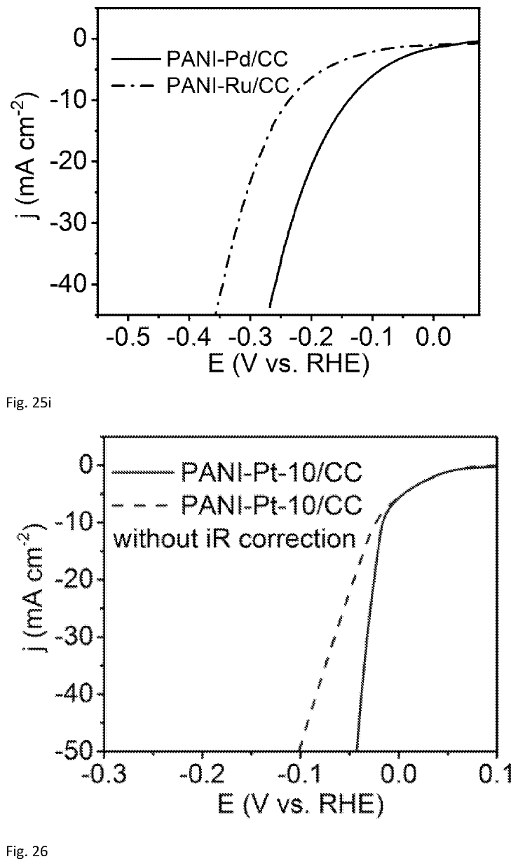

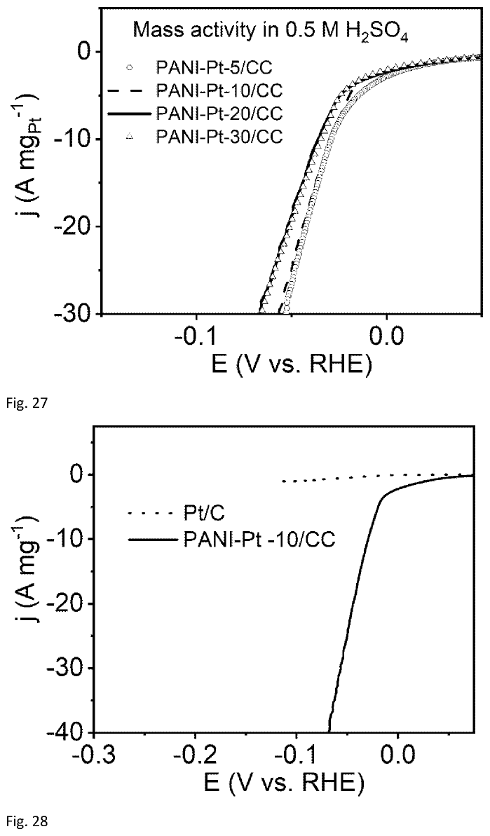

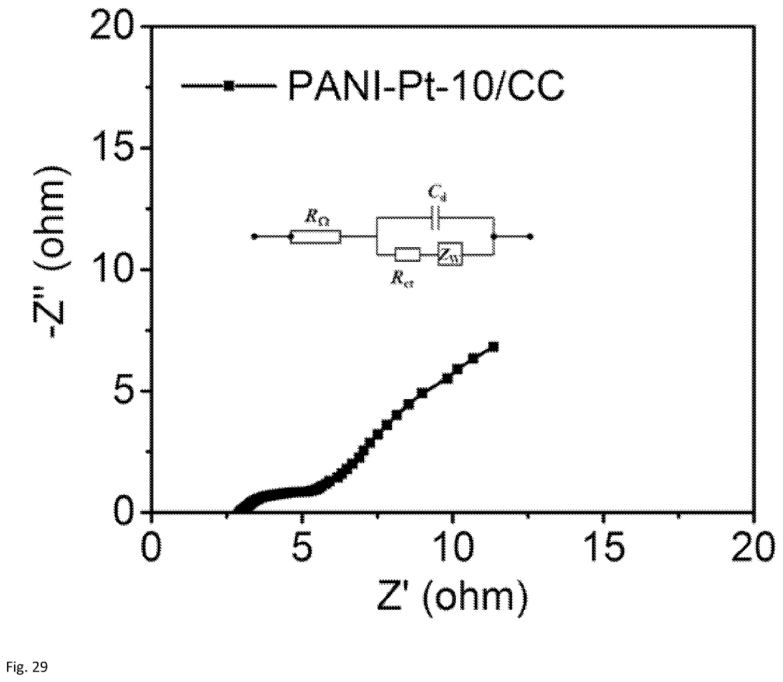

To achieve a current density of 10 mA cm⁻² (j₁₀), the PANI-Pt-5/CC, PANI-Pt-10/CC, PANI-Pt-20/CC and PANI-Pt-30/CC display overpotentials (η) of 23, 16 (23 mV without iR correction, FIG. 26), 16 and 18 mV in 0.5 M H₂SO₄ solutions (FIG. 25b), respectively. In addition, the Tafel slope for PANI-Pt-10/CC, PANI-Pt-20/CC, and PANI-Pt-30/CC is nearly 30±2 mV dec-1 (FIG. 25c), further demonstrating their similar intrinsic catalytic activity. The HER activity of commercial Pt/C (20 wt %), PANI/CC and blank CC were also investigated for comparison. Similarly, when the catalytic activity is calculated by Pt mass, the PANI-Pt-5/CC, PANI-Pt-10/CC, PANI-Pt-20/CC, PANI-Pt-30/CC show similar mass activities (FIG. 27), suggesting almost all atomic-dispersed Pt were active sites. As illustrated in FIG. 25d, blank CC and PANI/CC exhibit poor HER activity, while PANI-Pt-10/CC has a better HER activity than commercial Pt/C in the high current density region (j≥20 mA cm⁻²) (FIG. 25e). Impressively, such impressive HER catalytic activity of PANI-Pt-10/CC is almost among the most active atomically dispersed electrocatalysts in acidic conditions reported so far (Table 2). The Tafel slope for both PANI-Pt-10/CC and commercial Pt/C are closed to 30 mV dec⁻¹ (FIG. 25f), suggesting the typical Volmer-Tafel mechanism as the HER pathway.^{[A46]} It is worthwhile to mention that the mass activity for PANI-Pt-10/CC attains 25 Å mg_{Pt}⁻¹ at η=50 mV, which is nearly 50 times higher than that of commercial 20 wt % Pt/C (FIG. 28). Additionally, the Nyquist plots in FIG. 29 display that the PANI-Pt-10/CC exhibits an extremely low charge transfer resistance (R_{ct}) of 2.7Ω, suggesting a fast electron transfer between the catalyst and electrolyte.^{[A47]}

TABLE 2
Comparison of HER performance in acid solutions for PANI-Pt-10/CC
with other HER single atoms electrocatalysts.

| | | | Tafel slope | |
|---|---|---|---|---|
| Catalysts | Electrolytes | n@ (mV@mA⁻²) | (mV dec⁻¹) | Ref. |
| PANI-Pt-10/CC | 0.5M H₂SO₄ | 16@10 | 30 | This |
| | | | | work |
| Pt-MoS₂ | 0.1M H₂SO₄ | ~150@10 | 96 | B1 |
| ALD50Pt/NGNs | 0.5M H₂SO₄ | 50@16 | 29 | B2 |
| 400-SWMT/Pt | 0.5M H₂SO₄ | 27@10 | 38 | B3 |
| Pt-GDY2 | 0.5M H₂SO₄ | ~50@30 | 38 | B4 |
| PtSA-NT-NF | 1.0M PBS | 24@10 | 30 | B5 |
| PtSAs/DG | 0.5M H₂SO₄ | 23@10 | 25 | B6 |
| Mo₂TiC₂Tₓ-Pt_{SA} | 0.5M H₂SO₄ | 30@10 | 30 | B7 |
| Pt@PCM | 0.5M H₂SO₄ | 105@10 | 65.3 | B8 |
| Pt₁-MoO_{3 -} ₓ | 0.5M H₂SO₄ | 23.3@10 | 28.8 | B9 |
| Pt SASs/AG | 0.5M H₂SO₄ | 12@10 | 29.33 | B10 |
| SANi-PtNWs | 1.0M KOH | 70@10 | 60.3 | B11 |
| Pt1/NMC | 0.5M H₂SO₄ | 55@100 | 26 | B12 |
| Pt-PVP/TNR@GC | 0.5M H₂SO₄ | 21@10 | 27 | B13 |
| Pd-MoS₂ | 0.5M H₂SO₄ | 78@10 | 62 | B14 |
| Pd/Cu-Pt NRs | 0.5M H₂SO₄ | 22.8@10 | 25 | B15 |
| Ru SAs@PN | 0.5M H₂SO₄ | 24@10 | 38 | B16 |
| Ru@Co-SAs/N-C | 1.0M KOH | 7@10 | 30 | B17 |
| Ru-MoS₂/CC | 1.0M KOH | 41@10 | 114 | B18 |
| RuCₓN_{y} | 1.0M KOH | 12@10 | 14 | B19 |
| Fe/GD | 0.5M H₂SO₄ | 66@10 | 37.8 | B20 |
| Ni/GD | 0.5M H₂SO₄ | 88@10 | 45.8 | B20 |
| A-Ni-C | 0.5M H₂SO₄ | 34@10 | 41 | B21 |
| Ni-doped graphene | 0.5M H₂SO₄ | 180@10 | 45 | B22 |
| A-Ni@DG | 0.5M H₂SO₄ | 70@10 | 31 | B23 |
| Co-NG | 0.5M H₂SO₄ | 147@10 | 82 | B24 |
| Co₁/PCN | 1.0M KOH | 138@10 | 52 | B25 |
| Mo₁N₁C₂ | 0.5M H₂SO₄ | 154@10 | 86 | B26 |
| W₁N₁C₃ | 0.5M H₂SO₄ | 105@10 | 58 | B27 |

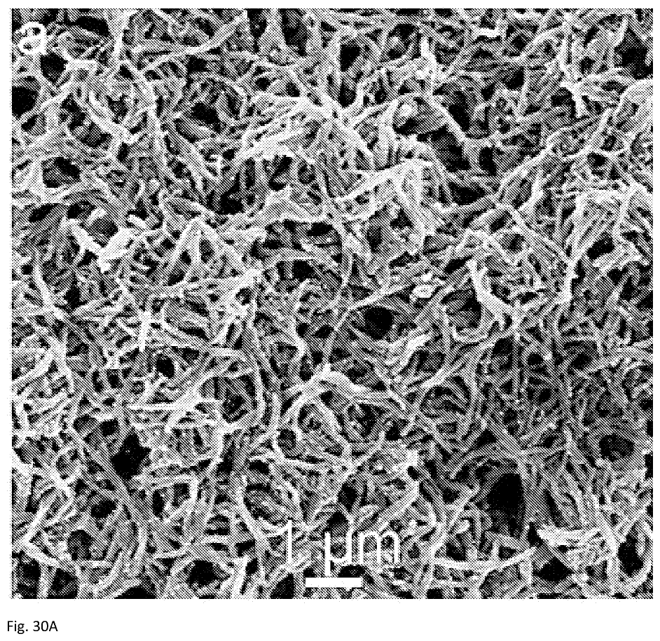

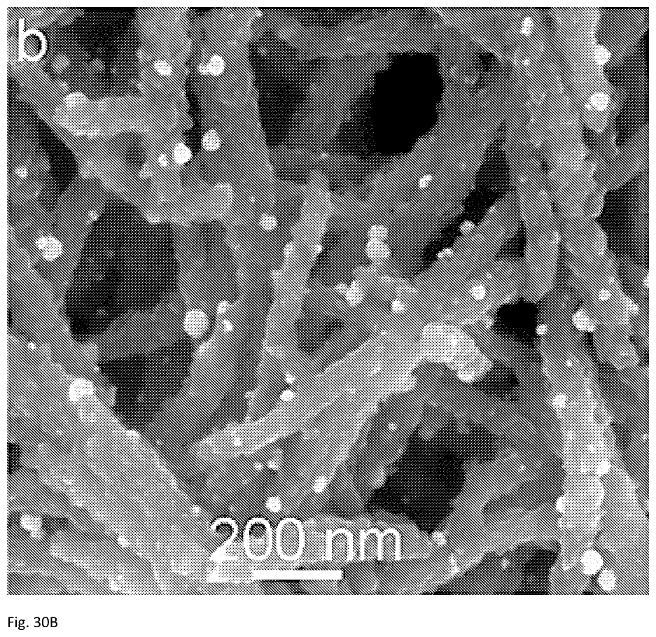

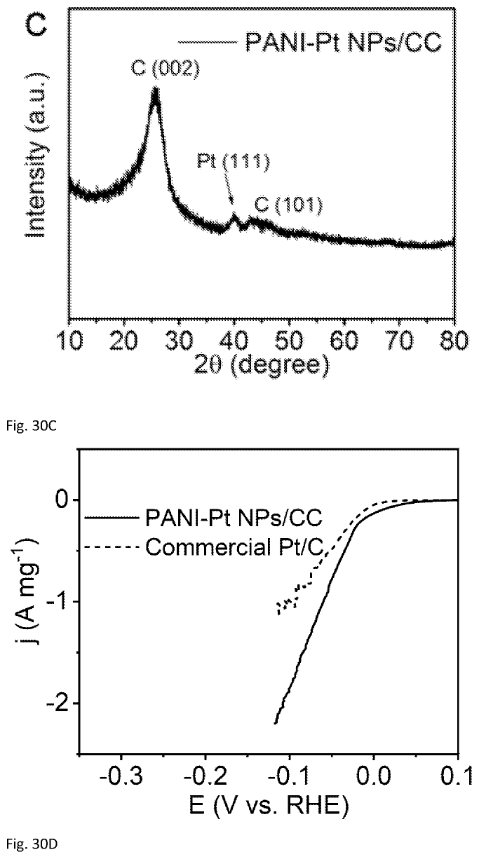

It is worth mentioning that the catalyst of Pt nanoparticles (Pt NPs) on the surface of PANI supported on carbon cloth (PANI-Pt NPs/CC) has been prepared by H₂ reduction at 200° C. As illustrated in FIG. 30a-c, the SEM and XRD patterns demonstrate that PANI supported Pt NPs has been successfully obtained. More importantly, the HER mass activity of PANI-Pt NPs/CC exhibits slightly higher than that of commercial Pt/C catalyst (FIG. 30d), which could be attributed to the following reasons: (1) the 3D self-supported materials offer huge specific surface area to maximize the utilization efficiency of catalytic active sites and to facilitate efficient mass transport of reactant (H⁺ ion) and gaseous product (H₂).^{[A48,49]} (2) Benefitting from the lone electron pairs on N atoms, PANI fibers can easily capture H⁺ from solutions and thus eliminate the effect of coordinating water molecules around H⁺, promoting the HER process, with higher HER catalytic activity than that of the commercial Pt/C catalyst in acid solutions.^{[A36]}

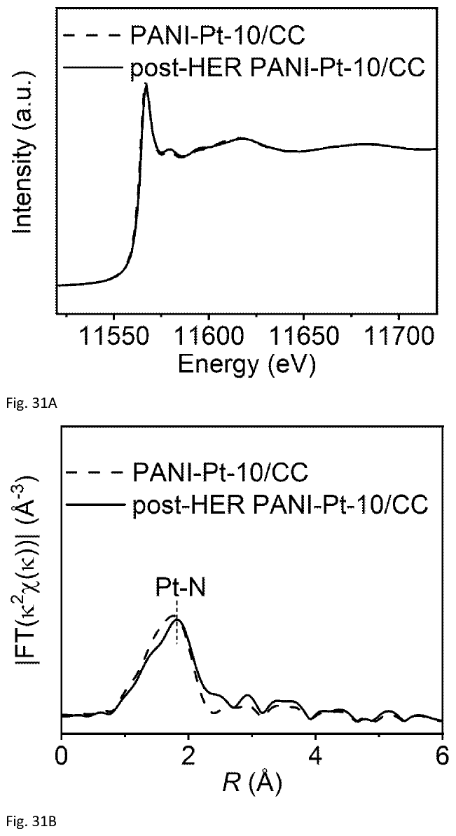

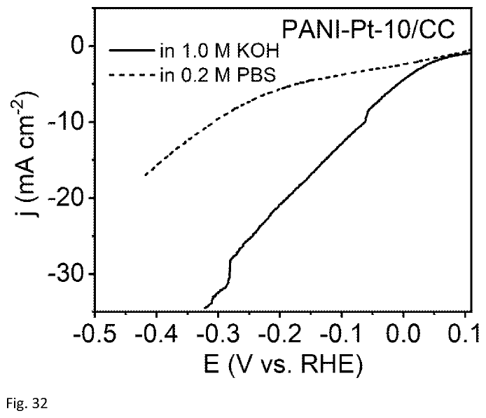

Durability is another important parameter in evaluating HER catalysts. The stability of commercial Pt/C and PANI-Pt-10/CC was evaluated by continuous cyclic voltammetry (CV) cycles under 0.5 M H₂SO₄ solutions. As shown in FIG. 25g, the LSVs for PANI-Pt-10/CC exhibit negligible degradation, whereas commercial 20 wt % Pt/C displays an obvious change. For example, at a current density of 10 milliamperes per square centimeter, the LSV of commercial 20 wt % Pt/C has a ˜13 mV negatively potential degradation after only 1,000 CV cycles. Furthermore, the chronopotentiometric curves show that the PANI-Pt-10/CC catalyst maintains its high stability for over 20 h in 0.5 M H₂SO₄ solutions (FIG. 25h). In other words, both the LSV test after 1,000 cycles and chronopotentiometry experiment demonstrate that the PANI-Pt-10/CC possesses great stability. Moreover, the XANES spectra indicate that the WL intensity for fresh and post-HER PANI-Pt-10/CC is almost identical to each other (FIG. 31a), further confirming its excellent stability. The FT-EXAFS spectra demonstrate that the bond length and local coordination have no obvious change after the durability test (FIG. 31b). The low stability of commercial Pt/C materials could be attributed to the following reasons: on one hand, some of Pt nanoparticle desorption from the glassy carbon electrode surface (a slight decrease in mass loading) is the likely cause of this small increase in overpotential. Owing to the vigorous gas evolution during the HER process, the durability under HER conditions is disappointingly low for most powder electrocatalysts as there are no strategies to securely fix powder catalysts onto electrode surfaces.^{[A50]}. On the other hand, the Pt nanoparticles supported on the carbon materials may inevitably be detachment, dissolution, redeposition, migration, and agglomeration due to the weak interaction between the C substrate and the supported Pt particles, and therefore resulting in poor stability.^{[A51-54]} All these results indicate the excellent stability of PANI-Pt-10/CC toward HER in 0.5 M H₂SO₄ solutions. The PANI-Pt-10/CC material also exhibits good catalytic activity under neutral and basic conditions (FIG. 32). It is worth noting that the atomically dispersed metal Ru and Pd on PANI fibers also show a great HER catalytic activity, as illustrated in FIG. 25i.

### CONCLUSION

In conclusion, a facile, simple and fast in-situ electrochemical reduction method was reported, for the first time, for the synthesis of a series of atomically dispersed metal sites on PANI nanofibers. For example, the atomically dispersed Pt sites anchored on PANI (PANI-Pt/CC) exhibit a higher HER catalytic activity and better durability than a commercial Pt/C catalyst in acid solutions. To attain a current density of 20 mA cm′, the PANI-Pt-10/CC only needs an overpotential of 25 mV. More importantly, the mass activity for PANI-Pt-10/CC at η=50 mV is nearly 50 times higher than that of commercial 20 wt % Pt/C. This universal in-situ electrochemical reduction strategy opens up a new avenue for the design of atomically dispersed metal sites supported on conducting polymers toward HER and beyond.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
A1. R. W. Coughlin, M. Farooque, Nature 1979, 279, 301.
A2. X. Lu, L. Yu, J. Zhang, X. Lou, Adv. Mater. 2019, 31, 1900699.
A3. J. A. Turner, Science 2004, 305, 972-974.
A4. M. S. Dresselhaus, I. L. Thomas, Nature 2001, 414, 332-337.
A5. Z. W. Seh, J. Kibsgaard, C. F. Dickens, I. Chorkendorff, J. K. Nørskov, T. F. Jaramillo, Science 2017, 355, 4998.
A6. M. G. Walter, E. L. Warren, J. R. McKone, S. W. Boettcher, Q. Mi, E. A. Santori, N. S. Lewis, Chem. Rev. 2010, 110, 6446-6473.
A7. D. Liu, X. Li, S. Chen, H. Yan, C. Wang, C. Wu, Y. A. Haleem, S. Duan, J. Lu, B. Ge, P. M. Ajayan, Y. Luo, J. Jiang, L. Song. Nat. Energy 2019, 4, 512-518.
A8. P. Chen, T. Zhou, M. Zhang, Y. Tong, C. Zhong, N. Zhang, L. Zhang, C. Wu, Y. Xie, Adv. Mater. 2017, 29, 1701584.
A9. H. Duan, D. Li, Y. Tang, Y. He, S. Ji, R. Wang, H. .Lv, P. Lopes, A. Paulikas, H. Li, S. Mao, C. Wang, N. Mar-kovic, J. Li, V. Stamenkovic, Y. Li, J. Am. Chem. Soc. 2017, 139, 5494-5502.
A10. H. Yan, C. Tian, L. Wang, A. Wu, M. Meng, L. Zhao, H. Fu, Angew. Chem., Int. Ed. 2015, 54, 6325-6329.
A11. Y. Zheng, Y. Jiao, M. Jaroniec, S. Z. Qiao, Angew. Chem., Int. Ed. 2015, 54, 52-65.
A12. L. T. Alameda, C. F. Holder, J. L. Fenton, R. E. Schaak, Chem. Mater. 2017, 29, 8953-8957.
A13. E. J. Popczun, J. R. McKone, C. G. Read, A. J. Biacchi, A. M. Wiltrout, N. S. Lewis, R. E. Schaak, J. Am. Chem. Soc. 2013, 135, 9267-9270.
A14. C. Tang. N. Cheng, Z. Pu, W. Xing, X. Sun, Angew. Chem., Int. Ed. 2015, 54, 9351-9355.
A15. J. Tian, Q. Liu, N. Cheng, A. M. Asiri, X. Sun, Angew. Chem., Int. Ed. 2014, 53, 9577-9581.
A16. C. Tang, L. Gan, R. Zhang, W. Lu, X. Jiang, A. M. Asiri, X. Sun, J. Wang, L. Chen, Nano Lett. 2016, 16, 6617-6621.

A17. C. Ray, S. Dutta, Y. Negishi, T. Pal, Chem. Commun. 2016, 52, 6095-6098.

A18. R. Zhang, C. Tang, R. Kong, G. Du, A. M. Asiri, L. Chen, X. Sun, Nanoscale, 2017, 9, 4793-4800.
A19. P. Xiao, W. Chen, X. Wang, Adv. Energy Mater. 2015, 4, 1500985.
A20. Q. Li, X. Zou, X. Ai, H. Chen, L. Sun, X. Zou, Adv. Energy Mater. 2019, 9, 1803369.
A21. C. Li, Z. Chen, H. Yi, Y. Cao, L. Du, Y. Hu, F. Kong, R. K. Campen, Y. Gao, C. Du, G. Yin, I. Y. Zhang, Y. Tong, Angew. Chem., Int. Ed. 2020, 132, 16036-16041.
A22. X. F. Yang, A. Wang, B. Qiao, J. Li, J. Liu, T. Zhang, Acc. Chem. Res. 2013, 46, 1740-1748.
A23. B. Bayatsarmadi, Y. Zheng, A. Vasileff, S. Z. Qiao, Small 2017, 13, 1700191.
A24. X. Yin, H. Wang, S. Tang, X. Lu, M. Shu, R. Si, T. Lu, Angew. Chem., Int. Ed. 2018, 57, 9382-9386.
A25. J. N. Tiwari, S. Sultan, C. W. Myung, T. Yoon, N. Li, M. Ha, A. M. Harzandi, H. J. Park, D. Y. Kim, S. S. Chandra-sekaran, W. G. Lee, V. Vij, H. Kang, T. J. Shin, H. S. Shin, G. Lee, Z. Lee, K. S. Kim, Nat. Energy 2018, 3, 773-782.
A26. J. Zhang, Y. Zhao, X. Guo, C. Chen, C. Dong, R. Liu, C. Han, Y. Li, Y. Gogotsi, G. Wang, Nat. Catal. 2018, 11, 985-992.
A27. Y. Chen, S. Ji, W Sun, W. Chen, J. Dong, J. Wen, J. Zhang, Z. Li, L. Zheng, C. Chen, Q. Peng, D. Wang, Y. Li, J. Am. Chem. Soc. 2018, 140, 7407-7410.
A28. H. Wei, X. Liu, A. Wang, L. Zhang, B. Qiao, X. Yang, Y. Huang, S. Miao, J. Liu, T. Zhang, Nat. Commun. 2014, 5, 5634.
A29. L. Zhang, R. Si, H. Liu, N. Chen, Q. Wang, K. Adair, Z. Wang, J. Chen, Z. Song, J. Li, M. N. Banis, R. Li, T.-K. Sham, M. Gu, L. M. Liu, G. A. Botton, X. Sun, Nat. Commun. 2019, 10, 4936.
A30. J. Wang, Z. Huang, W. Liu, C. Chang, H. Tang, Z. Li, W. Chen, C. Jia, T. Yao, S. Wei, Y. Wu, Y. Li, J. Am. Chem. Soc. 2017, 139, 17281-17284.
A31. J. Jones, H. Xiong, A. T. DeLaRiva, E. J. Peterson, H. Pham, S. R. Challa, G. Qi, S. Oh, M. H. Wiebenga, X. I. P. Hernandez, Y. Wang, A. K. Datye, Science 2016, 353, 150-154.
A32. Y. Zhang, L. Guo, L. Tao, Y. Lu, S. Wang, Small Methods 2019, 3, 1800406.
A33. J. Zhang, Y. Zhao, X. Guo, C. Chen, C. Dong, R. Liu, C. Han, Y. Li, Y. Gogotsi, G. Wang, Nat. Catal. 2018, 1, 985-992.
A34. Yu. Qu, B. Chen, Z. Li, X. Duan, L. Wang, Y. Lin, T. Yuan, F. Zhou, Y. Hu, Z. Yang, C. Zhao, J. Wang, C. Zhao, Y. Hu, G. Wu, Q. Zhang, Q. Xu, B. Liu, P. Gao, R. You, W. Huang, L.g Zheng, L. Gu, Y. Wu, Y. Li, J. Am. Chem. Soc. 2019, 141, 4505-4509.
A35. D. Hatchett, M. Josowicz, J. Janata, J. Phys. Chem. B 1999, 103, 10992.
A36. J. Feng, S. Tong, Y. Tong, G. Li, J. Am. Chem. Soc. 2018, 140, 5118-5126.
A37. P. Xiong, X. Zhang, H. Wan, S. Wang, Y. Zhao, Y. Zhao, J. Zhang, D. Zhou, W. Gao, R. Ma, T. Sasaki, G. Wang, Nano Lett. 2019, 19, 4518-4526.
A38. Z. Wang, X. Hao, Z. Jiang, X. Sun, D. Xu, J. Wang, H. Zhong, F. Meng, X. Zhang, J. Am. Chem. Soc. 2015, 137, 15070-15073.
A39. T. Li, J. Liu, Y. Song, F. Wang, ACS Catal. 2018, 8, 8450-8458.
A40. J. Bao, X. Zhang, B. Fan, J. Zhang, M. Zhou, W. Yang, X. Hu, H. Wang, B. Pan, Y. Xie, Angew. Chem., Int. Ed. 2015, 127, 7507-7512.
A41. S. Ye, F. Luo, Q. Zhang, P. Zhang, T. Xu, Q. Wang, D. He, L, Guo, Y. Zhang, C. He, X. Ouyang, M. Gu, J. Liu, X. Sun, Energy Environ. Sci. 2019, 12, 1000-1007.
A42. K. Jiang, B. Liu, M. Luo, S. Ning, M. Peng, Y. Zhao, Y. Lu, T. Chan, F. M. F. de Groot, Y. Tan, Nat. Commun. 2019, 10, 1743.
A43. P. Chen, T. Zhou, L. Xing, K. Xu, Y. Tong, H. Xie, L. Zhang, W. Yan, W. Chu, C. Wu, Y. Xie, Angew. Chem. Int. Ed. 2017, 56, 610-614.
A44. S. Fang, Xi. Zhu, X. Liu, J. Gu, W. Liu, D. Wang, W. Zhang, Y. Lin, J. Lu, S. Wei, Y. Li, T. Yao, Nat. Commun. 2020, 11, 1029.
A45. X. Sun, Y. Du, L. Zhang, S. Dong, E. Wang, Anal. Chem. 2007, 79, 2588-2592.
A46. Y. Jiao, Y. Zheng, K. Davey, S. Z. Qiao, Nat. Energy 2016, 1, 16130.
A47. D. Pech, M.i Brunet, H. Durou, P. Huang, V. Mochalin, Y. Gogotsi, P. Taberna, P. Simon, Nat. Nanotechnol. 2010, 5, 651-654.
A48. Z. Lu, W. Zhu, X. Yu, H. Zhang, Y. Li, X. Sun, X. Wang, H. Wang, J. Wang, J. Luo, X. Lei, L. Jiang, Adv. Mater. 2014, 26, 2683.
A49. Q. Song, Z. Xue, C. Liu, X. Qiao, L. Liu, C. Huang, K. Liu, X. Li, Z. Lu, T. Wang, J. Am. Chem. Soc. 2020, 142, 1857.
A50. C. Andronescu, S. Barwe, E. Ventosa, J. Masa, E. Vasile, B. Konkena, S. Möller, W. Schuhmann, Angew. Chem., Int. Ed. 2017, 56, 11258-11262.
A51. Y. Liu, W. E. Mustain, Int. J. Hydrogen Energy 2012, 37, 8929.
A52. Pandy, Z. Yang, M. Gummalla, V. V. Atrazhev, N. Y. Kuzminyh, V. I. Sultanov, S. Burlatsky, J. Electrochem Soc. 2013, 160, F972.
A53. Kregar, G. Tavc̆ar, A. Kravos, T. Katras̆nik, Appl. Energy 2020, 263, 114547.
A54. N. Cheng, M. N. Banis, J. Liu, A. Riese, S. Mu, R. Li, T. Sham, X. Sun, Energy Environ. Sci. 2015, 8, 1450-1455.
B1. J. Deng, H. B. Li, J. P. Xiao, Y. C. Tu, D. H. Deng, H. X. Yang, H. F. Tian, J. Q. Li, P. J. Ren, X. H. Bao, Energy Environ. Sci. 2015, 8, 1594-1601.
B2. N. Cheng, S. Stambula, D. Wang, M. N. Banis, J. Liu, A. Riese, B. Xiao, R. Li, T. K. Sham, L. Liu, G. A. Botton, X. Sun. Nat. Commun. 2016, 7, 13638.
B3. M. Tavakkoli, N. Holmberg, R. Kronberg, H. Jiang, J. Sainio, E. I. Kauppinen, T. Kallio, K. Laasonen, ACS Catal. 2017, 7, 3121-3130.
B4. L. Zhang, L. Han, H. Liu, X. Liu, J. Luo, Angew. Chem., Int. Ed. 2017, 56, 13694-13698.
B5. Y. Qu, B. Chen, Z. Li, X. Duan, L. Wang, Y. Lin, T. Yuan, F. Zhou, Y. Hu, Z. Yang, C. Zhao, J. Wang, C. Zhao, Y. Hu, G. Wu, Q. Zhang, Q. Xu, B. Liu, P. Gao, R. You, W. Huang, L. Zheng, L. Gu, Y. Wu, Y. Li, J. Am. Chem. Soc. 2019, 141, 4505-4509.
B6. H. Zhang, P. An, W. Zhou, B. Y. Guan, P. Zhang, J. Dong, X. W. Lou, Sci. Adv. 2018, 4, eaao6657.
B7. W. Liu, Q. Xu, P. F. Yan, J. Chen, Y. Du, S. Q. Chu, J. O. Wang, ChemCatChem 2018, 10, 946-950.
B8. M. Li, K. Duanmu, C. Wan, T. Cheng, Zhang, S. Dai, W. Chen, Z. Zhao, P. Li, H. Fei, Y. Zhu, R. Yu, J. Luo, K. Zang, Zh. Lin, M. Ding, J. Huang, H. Sun, J. Guo, X. Pan, W. A. Goddard, P. Sautet, Y. Huang, X. Duan, Nat. Catal. 2019, 2, 495-503.
B9. H. Wei, H. Wu, K. Huang, B. Ge, J. Ma, J. Lang, D. Zu, M. Lei, Y. Yao, W. Guo, H. Wu, Chem. Sci. 2019, 10, 2830-2836.
B10. Z. Luo, Y. ouyang, H. Zhang, M. Xiao, J. Ge, Z. Jiang, J. Wang, D. Tang, X. Cao, C. Liu, W. Xing, Nat. Commun. 2018, 9, 2120.
B11. T. T. Chao, X. Luo, W. X. Chen, B. Jiang, J. J. Ge, Y. Lin, G. Wu, X. Q. Wang, Y. M. Hu, Z. B. Zhuang, Y. Wu, X. Hong, Y. D. Li, Angew. Chem., Int. Ed. 2017, 56, 16047-16051.
B12. J. Yang, B. Chen, X. Liu, W. Liu, Z. Li, J. Dong, W. Chen, W. Yan, T. Yao, X. Duan, Y. Wu, Y. Li, Angew. Chem., Int. Ed. 2018, 57, 9495-9500.
B13. S. Yuan, Z. Pu, H. Zhou, J. Yu, I. S. Amiinu, J. Zhu, Q. Liang, J. Yang, D. He, Z. Hu, G. V. Tendeloo, S. Mu, Nano Energy 2019, 59, 472-480.
B14. D. Wang, Q. Li, C. Han, Z. Xing, X. Yang, Appl. Catal. B: Environ. 2019, 249, 91-97.
B15. B. Lu, L. Guo, F. Wu, Y. Peng, J. Lu, T. J. Smart, N. Wang, Y. Finfrock, D. Morris, P. Zhang, N. Li, P. Gao, Y. Ping, S. Chen, Nat. Commun. 2019, 10, 631.
B16. Y. Xue, B. Huang, Y. Yi, Y. Guo, Z. Zuo, Y. Li, Z. Jia, H. Liu, Y. Li, Nat. Commun. 2018, 9, 1460.
B17. L. Fan, P. Liu, X. Yan, L. Gu, Z. Yang, H. Yang, S. Qiu, X. Yao, Nat. Commun. 2016, 7, 10667.
B18. H. J. Qiu, Y. Ito, W. Cong, Y. Tan, P. Liu, A. Hirata, T. Fujita, Z. Tang, M. Chen, Angew. Chem., Int. Ed. 2015, 54, 14031-14035.
B19. L. Zhang, Y. Jia, G. Gao, X. Yan, N. Chen, J. Chen, M. T. Soo, B. Wood, D. Yang, A. Du, X. Yao, Chem 2018, 4, 1-13.
B20. H. Fei, J. Dong, M. J. Arellano-Jimenez, G. Ye, N. Dong Kim, E. L. Samuel, Z. Peng, Z. Zhu, F. Qin, J. Bao, M. J. Yacaman, P. M. Ajayan, D. Chen, J. M. Tour, Nat. Commun. 2015, 6, 8668.
B21. L. Cao, Q. Luo, W. Liu, Y. Lin, X. Liu, Y. Cao, W. Zhang, Y. Wu, J. Yang, T. Yao, S. Wei, Nat. Catal. 2019, 2,134-141.
B22. W. Chen, J. Pei, C. He, J. Wan, H. Ren, Y. Zhu, Y. Wang, J. Dong, S. Tian, W. Cheong, S. Lu, L. Zheng, X. Zheng, W. Yan, Z. Zhuang, C. Chen, Q. Peng, D. Wan, Y. Li, Angew. Chem., Int. Ed. 2017, 129, 16302-16306.
B23. W. Chen, J. Pei, C. He, J. Wan, H. Ren, Y. Wang, J. Dong, K. Wu, W. Cheong, J. Mao, X. Zheng, W. Yan, Z. Zhuang, C. Chen, Q. Peng, D. Wang, Y. Li, Adv. Mater. 2018, 30, 1800396.
CN105529475B
US 20190276943 A1
CN107626294B
US 2021/0047741 A1
CN109225301B
CN106914237B
Energy Environ. Sci. 2015, 8, 1594
Nat. Commun. 2016, 7, 13638
ACS Catal. 2017, 7, 3121
Angew. Chem., Int. Ed. 2018, 57, 9382
Angew. Chem., Int. Ed. 2017, 56, 13694
J. Am. Chem. Soc. 2019, 141, 4505
Nat. Catal. 2018, 1, 985
Adv. 2018, 4, eaao6657
ChemCatChem 2018, 10, 946
Energy Environ. Sci. 2019, 12, 1000
Nat. Catal. 2019, 2, 495
Chem. Sci. 2019, 10, 2830
Angew. Chem., Int. Ed. 2020, 132, 16036
Nat. Commun. 2020, 11, 1029
Nat. Commun. 2018, 9, 2120
Angew. Chem., Int. Ed. 2017, 56, 16047
Angew. Chem., Int. Ed. 2018, 57, 9495
Nano Energy 2019, 59, 472
Appl. Catal. B: Environ. 2019, 249, 9
Nat. Commun. 2019, 10, 631

1. A single-atom catalyst comprising nanofibers of a conductive material and a plurality of single-atom metal sites uniformly dispersed on the surface of each of the nanofibers, wherein each single-atom metal site comprises a single atom of each of one or more metal adsorbed on the surface of one of the nanofibers, and wherein the single-atom metal sites contain the same metal(s) or different metals.

2. (canceled)

3. The catalyst of claim 1, wherein each single-atom metal site comprises a single atom of one metal.

4. The catalyst of claim 3, wherein the one metal is a transition metal, a rare earth metal, Ru, Pd, or Pt.

5. The catalyst of claim 4, wherein the one metal is Pt with an oxidation state (δ⁺) of 4>δ⁺>0.

6.-7. (canceled)

8. The catalyst of claim 1, wherein the conductive material is a metal, a conductive oxide-based porous material, a conductive carbon material, or a conductive polymer.

9.-10. (canceled)

11. The catalyst of claim 8, wherein the conductive polymer is poly(pyrrole), polycarbazole, polyindole, polyazepines, polyaniline, poly (3,4-ethylenedioxythiophene), or poly(p-phenylene sulfide).

12.-16. (canceled)

17. The catalyst of claim 1, wherein the nanofibers are supported onto a conductive substrate.

18. The catalyst of claim 17, wherein the conductive substrate is Ni, Co, Fe, Cu, Ti, Mo, a metal-based foam, plate, or mesh, carbon cloth, carbon paper, or graphite foam.

19.-20. (canceled)

21. The catalyst of claim 1, wherein when observed by high-resolution transmission electron microscopy (HRTEM), the catalyst appears free of clusters or nanoparticles of the metal(s).

22. (canceled)

23. The catalyst of claim 1, wherein the metal(s) are anchored on nitrogen atoms at the surface of the nanofibers.

24.-27. (canceled)

28. A method of manufacturing the single-atom catalyst of claim 1, the method comprising the steps of:
A. providing a conductive substrate,
B. electrodepositing nanostructures of a conductive material on the substrate or drop-casting a suspension of the nanostructures of a conductive material on the substrate, wherein said nanostructures have a negative surface charge,
C. adsorbing one or more complex ions on the surface of the nanostructures, each complex ion comprising a single atom of each of one or more metal and having a total negative charge, and
D. electrochemical reducing the metal(s), thereby producing the catalyst.

29. The method of claim 28, wherein the nanostructures are subnano-clusters, nanoparticles, or nanofibers.

30. (canceled)

31. The method of claim 28, wherein step B comprises drop-casting a suspension of the nanostructures of a conductive material on the substrate.

32.-33. (canceled)

34. The method of claim 28, wherein step B comprises electrodepositing nanostructures of a conductive material on the substrate using a three-electrode assembly comprising an electrolyte, the conductive substrate as a working electrode, a graphite electrode as a counter electrode, and an Ag/AgCl electrode as the reference electrode.

35. (canceled)

36. The method of claim 3, wherein the electrolyte comprises the conductive material or a monomer of the conductive materiel.

37. The method of claim 34, wherein the conductive material is polyaniline, and the electrolyte comprises aniline.

38. The method of claim 34, wherein the electrolyte further comprises an acid.

39. (canceled)

40. The method of claim 28, wherein step C comprises immersing the conductive substrate with the nanostructures in a solution comprising the complex ions, and allowing the complex ions to adsorb on the surface of the nanostructures.

41. The method of claim 40, wherein the complex ions are: FeF₆³⁻, Co(SCN)₄²⁻, Cr(CN)₆³⁻, Co(CN)₆³⁻, Fe(CN)₆³⁻, Ni(CN)₄²⁻, [Cu(NH₃)Cl₅]³⁻, [CuCl₃(H₂O)]⁻, RuCl₆²⁻, AuCl₄⁺, IrCl₆²⁻, PtCl₆²⁻, and/or PdCl₄²⁻.

42.-45. (canceled)

46. The method of claim 28, wherein step D comprises electrochemically reducing the metal(s) using one linear sweep voltammetry (LSV) scan.

47.-49. (canceled)
